(19) United States
(12) Patent Application Publication
(10) Pub. No.: US 2004/0038821 A1
(43) Pub. Date: Feb. 26, 2004

(54) Multicolor thermosensitive recording medium, method of manufacturing the same, and method of printing using the same

(75) Inventors: Toshiyuki Tamura, Mishima-shi (JP); Takayuki Hiyoshi, Suntou-gun (JP); Shinichi Mizushima, Mishima-shi (JP); Michio Suzuki, Tagata-gun (JP); Masami Yamanashi, Tagata-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba TEC Kabushiki Kaisha, Tokyo (JP)

(21) Appl. No.: 10/457,373

(22) Filed: Jun. 10, 2003

Related U.S. Application Data
(62) Division of application No. 10/404,123, filed on Apr. 2, 2003.
Application No. 10/404,123 is a division of application No. 09/808,355, filed on Mar. 15, 2001, now abandoned.

(30) Foreign Application Priority Data
Mar. 17, 2000 (JP) 2000-077292
Oct. 19, 2000 (JP) 2000-319134
Dec. 21, 2000 (JP) 2000-389344

(51) Int. Cl. B41M 5/30

(52) U.S. Cl. 503/204

(57) ABSTRACT

A multicolor thermosensitive recording medium according to the present invention comprises a first thermosensitive coloring layer which develops by the application of coloring energy, and a second thermosensitive coloring layer which develops in a different color from the first thermosensitive coloring layer by the application of coloring energy. At least one of a region wherein only the monochrome color of the first thermosensitive coloring layer is obtained without coloring the second thermosensitive coloring layer, and a region wherein only the monochrome color of the second thermosensitive coloring layer is obtained without coloring the first thermosensitive coloring layer, is provided in a printing region of the multicolor thermosensitive recording medium of the present invention. At least one of the region where only the monochrome color of the first thermosensitive coloring layer is obtained without coloring the second thermosensitive coloring layer, and the region where only the monochrome color of the second thermosensitive coloring layer is obtained without coloring the first thermosensitive coloring layer, can be obtained by preventing color mixing due to the first thermosensitive coloring layer when the second thermosensitive coloring layer is colored in the case where the second thermosensitive coloring layer is laminated over the first thermosensitive coloring layer. This prevention of color mixing may for example be realized by desensitizing or dulling the coloring function of the first thermosensitive coloring layer when it is necessary to develop the color of the second thermosensitive coloring layer.

### BACKGROUND OF THE INVENTION

1. Field of the Invention

The present invention relates to a multicolor thermosensitive recording medium which comprises plural thermosensitive coloring layers of different colors, which develop different colors. The present invention also relates to a method of manufacturing the medium, and method of printing using the medium.

2. Description of the Prior Art

To obtain forms which can be distinguished according to type by color difference, using thermosensitive recording medium, it is common to provide plural thermosensitive recording media whereon information is printed in different colors by offset printing etc. For example, for an invoice of a parcel delivery service, two kinds of thermosensitive form are printed, i.e., a payment by sender form and a C.O.D. form, in characters of different colors. When such a thermosensitive recording form is used, it is necessary to change the thermosensitive form depending on the customer.

The method of pre-printing by offset printing, etc. using a thermosensitive recording medium as a means of obtaining plural forms in multiple colors, is time-consuming and complicated. Also, as different thermosensitive recording media must be provided for each type of thermosensitive form, it is difficult to manage.

A method exists for producing plural forms from a single thermosensitive recording medium. Such a thermosensitive recording medium is known as a multicolor thermosensitive recording medium, as disclosed for example by Japanese Unexamined Patent Publication No. Sho 57-178791, etc. The multicolor thermosensitive recording medium disclosed by this publication is a recording medium comprising at least two thermosensitive coloring layers which develop different color tones at different coloring temperatures, formed on a substrate such as paper. Usually, in a multicolor thermosensitive recording medium of such construction, a high temperature thermosensitive coloring layer which develops a predetermined color at comparatively high temperature is made the lower layer, and a low-temperature thermosensitive coloring layer which develops a predetermined color at comparatively low temperature, is made the upper layer.

In the multicolor thermosensitive recording medium of such a construction, each thermosensitive coloring layer is generally heated and made to develop using a thermal head. In this case, in the multicolor thermosensitive recording medium, an image having a color tone which is different when heated to different temperatures, is obtained. For example, it develops blue when heated to comparatively low temperature, and it develops black when heated to comparatively high temperature.

The disadvantage of the above-mentioned prior art technique will now be described.

In this kind of multicolor thermosensitive recording medium, although there is no problem regarding the material which is heated at low temperature and develops at low temperature, there is a problem in that color mixing occurs at high temperature, and the sensitivity of the material which develops at high temperature could not be increased.

The problem of color mixing arises because, although the area around the dots heated by thermal elements of the thermal head becomes quite hot, the outlines of the dots develop a color characteristic of low temperature heating, so color mixing occurs in the outlines of the dots. When plural forms are produced from one multicolor thermosensitive recording medium, this color mixing cannot be avoided.

The reason why sensitivity of the material which develops at high temperature cannot be increased is because, as it is necessary to make a difference between the thermosensitive coloring material which develops at high temperature and the thermosensitive coloring material which develops at low temperature, the coloring sensitivity of the high temperature material had to be reduced.

One technique for partially printing a thermosensitive paper by a hot printing ink ribbon is disclosed in Japanese Unexamined Patent Publication No. Hei 8-2115, wherein in order to prevent color mixing with the thermosensitive paper, a layer comprising an erasing agent which suppresses or erases the coloring of the thermosensitive paper is provided to the ribbon.

However, in a multicolor thermosensitive recording medium, two or more thermosensitive coloring layers have to be provided over the whole surface of the recording medium surface, so increase of manufacturing cost could not be avoided,

In some cases, to avoid color mixing in the multicolor thermosensitive recording medium, it was necessary to raise the coloration start temperature. This increased the exothermic energy of the thermal head which heats the multicolor thermosensitive recording medium, leading to a reduced lifespan of the thermal head. In addition, high speed printing was impossible, and as a complex system was required to control the heating history to prevent color mixing, there was no way of preventing cost increase.

### SUMMARY OF THE INVENTION

It is therefore an object of the present invention to prevent the color mixing of outline shapes produced between plural thermosensitive coloring layers.

It is another object of the present invention to provide a multicolor thermosensitive recording medium which does not use thermosensitive coloring layers requiring high applied heat energy, and its printing method.

It is yet another object of the present invention to provide a manufacturing method permitting a multicolor thermosensitive recording medium to be manufactured easily.

The multicolor thermosensitive recording medium of the present invention comprises a first thermosensitive coloring layer which develops by application of coloring energy, and a second thermosensitive coloring layer which develops in a different color from the first thermosensitive coloring layer by application of coloring energy on a substrate. At least one of a region where coloration by monochrome coloring of only the first thermosensitive coloring layer is obtained without coloring the second thermosensitive coloring layer, and a region where coloration by monochrome coloring of only the second thermosensitive coloring layer is obtained without coloring the first thermosensitive coloring layer, is provided in the printing region of the multicolor thermosensitive recording medium of the present invention.

The method of manufacturing the multicolor thermosensitive recording medium of the present invention comprises a step for forming the first thermosensitive coloring layer over the whole surface of the substrate, a step for forming a desensitized region which desensitizes or dulls the coloring function in a part of the region of this first thermosensitive coloring layer, and a step for forming the second thermosensitive coloring layer over a wider region than the desensitized region on the first thermosensitive coloring layer so that the desensitized region is covered, using a thermosensitive coloring material which develops in a different color from the first thermosensitive coloring layer.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, in which:

FIG. 1 is a plan view of a multicolor thermosensitive recording medium according to a first embodiment of the present invention;

FIG. 2 is a longitudinal section of the multicolor thermosensitive recording medium;

FIG. 3 is a plan view of the multicolor thermosensitive recording medium;

FIG. 4 is a plan view of the multicolor thermosensitive recording medium;

FIG. 5 is a plan view of the multicolor thermosensitive recording medium;

FIG. 6 is a plan view of the multicolor thermosensitive recording medium;

FIG. 7 is a longitudinal section of a multilayer thermosensitive recording medium according to a second embodiment of the present invention;

FIG. 8 is a longitudinal section of a multicolor thermosensitive recording medium according to a third embodiment of the present invention;

FIG. 9 is a longitudinal section of a multicolor thermosensitive recording medium according to a seventh embodiment of the present invention;

FIG. 10 is a longitudinal section of a multicolor thermosensitive recording medium according to an eighth embodiment of the present invention;

FIG. 11 is a longitudinal section of a multicolor thermosensitive recording medium according to a ninth embodiment of the present invention;

FIG. 12 is a longitudinal section of a multicolor thermosensitive recording medium according to a modification of the same;

FIG. 13 is a longitudinal section of a multicolor thermosensitive recording medium according to a tenth embodiment of the present invention;

FIG. 14 is a longitudinal section of a multicolor thermosensitive recording medium according to a modification of the same;

FIG. 15(A) is a sectional view of a multicolor thermosensitive recording medium according to twelfth and thirteenth embodiments of the present invention;

FIG. 15(B) is a plan view of the same;

FIG. 16(A) is a sectional view of a multicolor thermosensitive recording medium according to a fourteenth embodiment of the present invention;

FIG. 16(B) is a plan view of the same;

FIG. 17(A) is a sectional view of a multicolor thermosensitive recording medium according to a fifteenth embodiment of the present invention;

FIG. 17(B) is a plan view of the same;

FIG. 18(A) is a sectional view of a multicolor thermosensitive recording medium according to a sixteenth embodiment of the present invention; and

FIG. 18(B) is a plan view of the same.

### DETAILED DESCRIPTION OF THE PREFERRED EMBODIMENTS

[Embodiment 1]

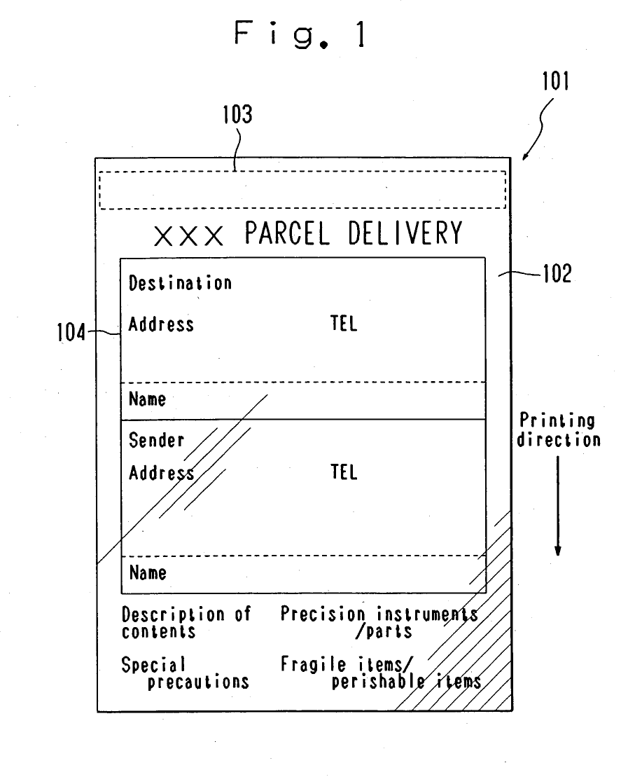

Embodiment 1 of the present invention will be described referring to FIG. 1 to FIG. 7.

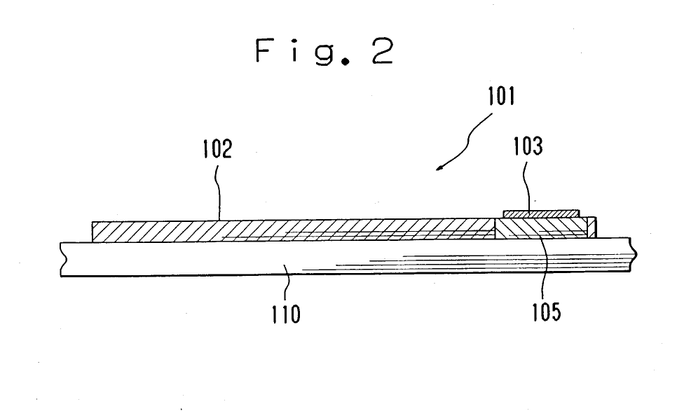

FIG. 1 is a plan view showing a schematic view of a multicolor thermosensitive recording medium 101 which is the first embodiment of the present invention, and FIG. 2 is a longitudinal section of the same. As shown in FIG. 1 and FIG. 2, this multicolor thermosensitive recording medium 101 is a sheet-like recording medium, and has a structure wherein plural thermosensitive coloring layers which develop in different colors are laminated on each other in the thickness direction of the sheet. At least one of the plural thermosensitive coloring layers is partially formed in the width direction of the sheet.

In this example, the multicolor thermosensitive recording medium 101 is provided with a first thermosensitive coloring layer 102 and second thermosensitive coloring layer 103 partially formed on the surface of this first thermosensitive coloring layer 102 on a substrate 110. The first thermosensitive coloring layer 102 comprises, for example, a leuco dye, a phenolic developer and a binder resin, and its melting point may be adjusted by other agents such as a sensitizer, if needed. The second thermosensitive coloring layer 103 comprises for example, a leuco dye, a developer, a sensitizer and a binder resin. There are no particular limitations on these materials, their characteristics being somewhat different in the various embodiments described later, it being sufficient if the materials possess these characteristics. The second thermosensitive coloring layer 103 develops a predetermined color when heated to a predetermined temperature. The first thermosensitive coloring layer 102 develops a predetermined color when heated to a predetermined temperature. The second thermosensitive coloring layer 103 develops a different color from the developing of the first thermosensitive coloring layer 102.

The details of the composition of the multicolor thermosensitive recording medium 101 of this first embodiment will now be described in detail referring to the longitudinal section shown in FIG. 2. As the first thermosensitive coloring layer 102, a thermosensitive paper which comprises a known leuco dye and a known developer (and other agents such as a sensitizer and a stabilizer, if necessary), can be used. Before partially coating and forming the second thermosensitive coloring layer 103 on the first thermosensitive coloring layer 102, an erasing agent is applied to block the coloring function of the first thermosensitive coloring layer 102 in the part where the second thermosensitive coloring layer 103 is to be developed. That is, when heat is applied to the first thermosensitive coloring layer 102 in the part where the second thermosensitive coloring layer 103 is to be developed, the coloring function is reduced. The second thermosensitive coloring layer 103 is partially coated over this to form the multicolor thermosensitive recording medium 101.

More specifically, the multicolor thermosensitive recording medium 101 may for example be manufactured as follows. In this example, the first thermosensitive coloring layer 102 is a well-known thermosensitive paper which comprises a substrate in one piece, for example, a material of a type which turns black, does not have a protection layer, and which starts developing a color even when the storage temperature is 60° C.

(A) Step 1—Apply the erasing agent to the first thermosensitive coloring layer 102.

The erasing agent was applied by partially coating polyethylene glycol #4000 (reagent) which has a melting point of 55° C. on a predetermined region of the surface of the first thermosensitive coloring layer 102 by the diecoat method. In this step, the thermosensitive paper, which is the first thermosensitive coloring layer 102, was heated to 60° C. After verifying that the erasing agent had permeated the first thermosensitive coloring layer 102, it was returned to room temperature, and the polyethylene glycol remaining in the first thermosensitive coloring layer 102 was removed to form a desensitized area 105.

(B) Step 2—Coat the second thermosensitive coloring layer 103 on the first thermosensitive coloring layer 102 after applying the erasing agent.

The material of the second thermosensitive coloring layer 103 was prepared by mixing the following two kinds of liquid dispersion.

(1) Leuco Dye and Sensitizer Liquid Dispersion (Composition as Follows):

RED—40-2.7 weight parts,

p-benzyl phenyl (PBBP)—2 weight parts,

PVA 10% solution—30 weight parts

water—40 weight parts.

(2) Developer Liquid Dispersion (Composition as Follows):

bisphenol A—6 weight parts,

oxidized starch—2 weight parts,

calcium carbide—2 weight parts,

PVA 10% solution—30 weight parts,

water—40 weight parts.

A mixture of the dispersions (1) and (2) was coated in stripes to a dry weight of 8 g/m² by a diecoater. Its position was on the position (desensitized area 105) coated by the erasing agent in the first step. The second thermosensitive coloring layer 103 formed on the first thermosensitive coloring layer 102 was cut to the size of the form shown in FIG. 1 to obtain the multicolor thermosensitive recording medium 101. Predetermined pre-printing 104 was then performed by flexographic or offset printing on the multicolor thermosensitive recording medium 101 formed in this way. A protective layer may also be formed on the multicolor thermosensitive recording medium 101 if necessary.

The first thermosensitive coloring layer 102 of the multicolor thermosensitive recording medium 101 manufactured as described above was printed black at 0.4 mJ/dot and printed red at 0.4 mJ/dot in the same way, using a thermal printing head (200 dpi) from Kyocera Corp. No color mixing at all was observed in parts under the red color in the second thermosensitive coloring layer 103.

Although polyethylene glycol was used as the erasing agent, the invention is not limited thereto. Various other materials which have a melting point above 40° C. at which the first thermosensitive coloring layer 102 does not develop, and which desensitize or dull the coloring of the first thermosensitive coloring layer 102, may be used. Here, the melting point of the erasing agent was taken above 40° C. because, assuming that the temperature at which the completed multicolor thermosensitive recording medium 101 is stored, is 40° C., it may be expected that there would be an effect on the second thermosensitive coloring layer 103 when the melting point of the erasing agent is higher than this temperature.

The second thermosensitive coloring layer 103 has another effect if it is formed in stripes as shown in FIG. 1. Namely, a wider range of coating methods can be used, and the difference in the form can be judged at a glance. For example, a partial coating method may be used for coating the second thermosensitive coloring layer 103 such as flexographic, screen, gravure printing or diecoating, which permits a reduction of manufacturing costs.

A desirable stripe form of the second thermosensitive coloring layer 103 is that shown for example in FIG. 1. In the example of FIG. 1, in forming the second thermosensitive coloring layer 103 on the first thermosensitive coloring layer 102, the direction perpendicular to the printing direction of the pre-printing 104 on the multicolor thermosensitive recording medium 1, is the longitudinal direction of the second thermosensitive coloring layer 103. In this case, the second thermosensitive coloring layer 103 is formed in stripes by the diecoater, etc. on the first thermosensitive coloring layer 102, and this is cut to the shape of the multicolor thermosensitive recording medium 101 to obtain a form.

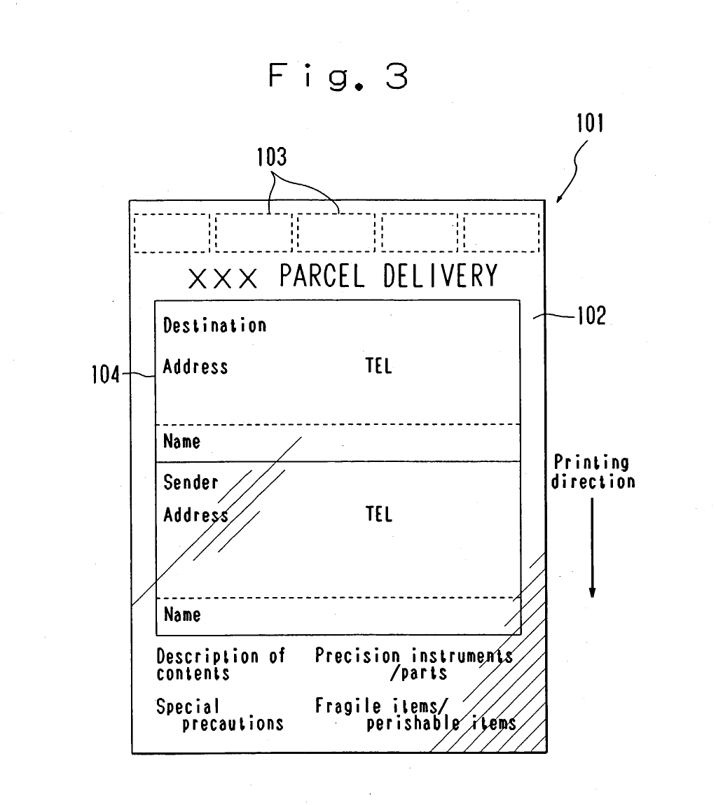

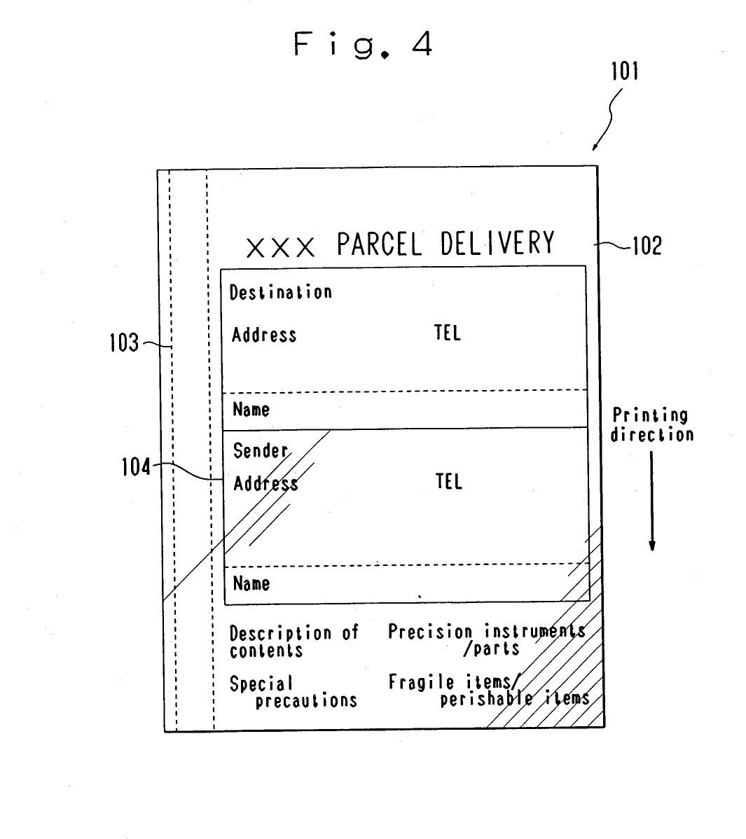

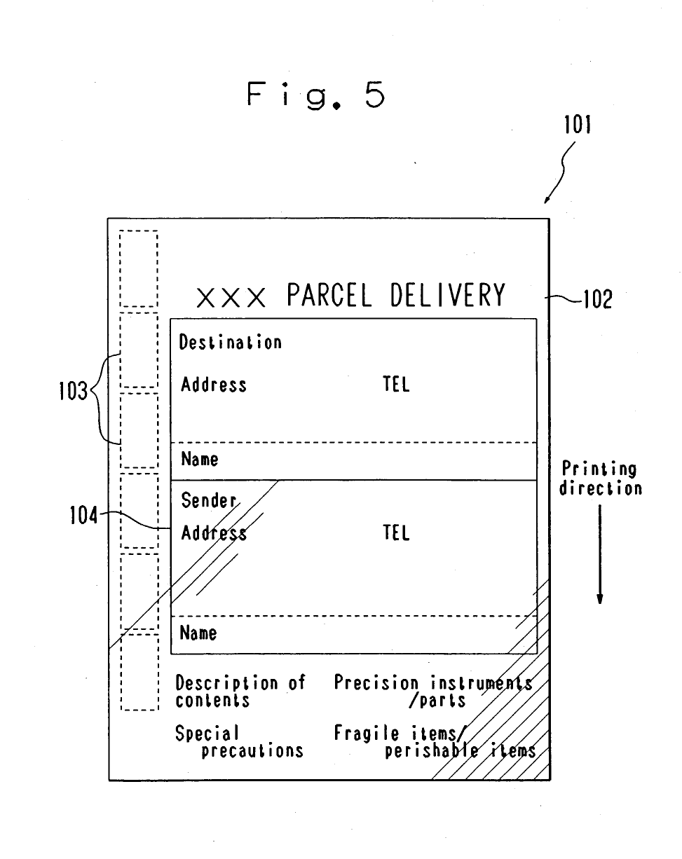

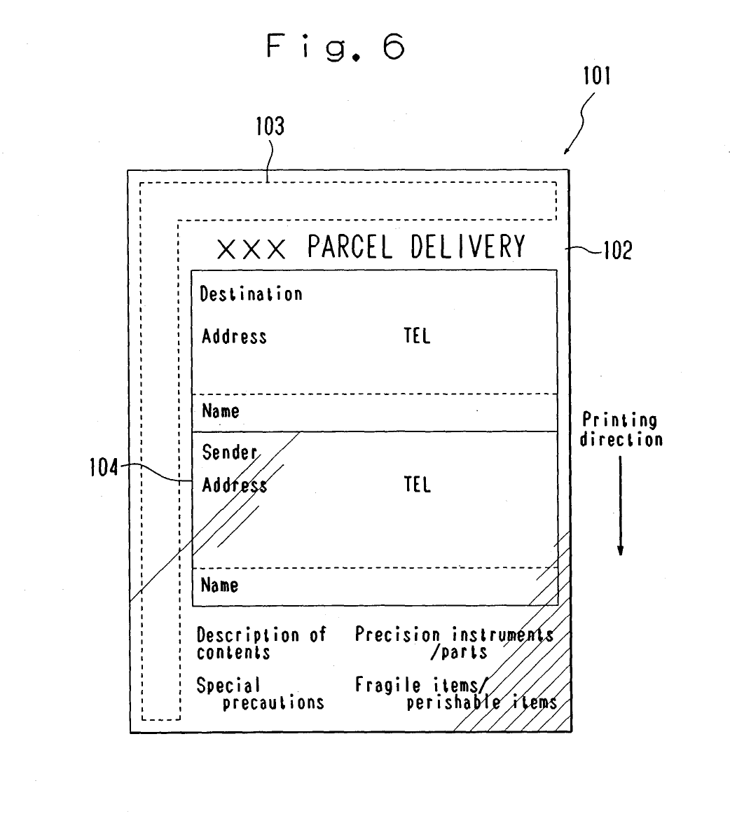

The example of FIG. 3 is the same as that of FIG. 1, but the stripes of the second thermosensitive coloring layer 103 are formed intermittently. This can be done by performing diecoating, etc., intermittently. The example of FIG. 4 is an example formed parallel to the printing direction. This may also be formed by the same method as that of FIG. 1, only the direction of application being different. The example of FIG. 5 can be formed by the same method as that of FIG. 3. The example of FIG. 6 can be formed by continuously coating part of the second thermosensitive coloring layer 103 with plural diecoating heads, and coating the remainder intermittently. The stripes of the second thermosensitive coloring layer 103 of FIG. 6 can also be formed intermittently. Further, although the stripes were formed here by coating, they may be formed by printing. Thus, the second thermosensitive coloring layer 103 formed in stripes can be formed by either coating or printing, and its coloring can be distinguished at a glance. Moreover, characters can also be printed on the stripe-like second thermosensitive coloring layer 103. Thus, the thermosensitive recording medium 1 is a form which can be printed or coated according to the desired use or composition, and on which the distinguishing pattern can be varied by stripes and characters.

[Embodiment 2]

Another embodiment of the present invention will now be described as Embodiment 2 with reference to FIG. 7.

In the description of Embodiment 2 of the present invention, the same symbols are used to denote identical components to those of Embodiment 1, and a detailed explanation of common technical features is omitted.

When the second thermosensitive coloring layer 103 is developed in Embodiment 1 of the invention, there is an inconsequential amount of color mixing, but in the second embodiment of the present invention, to eliminate this completely, an intermediate layer 106 is formed between the first thermosensitive coloring layer 102 and second thermosensitive coloring layer 103.

This color mixing is due to penetration of developer in the desensitized area 105 when the second thermosensitive coloring layer 103 is applied, and to penetration of developer of the second thermosensitive coloring layer 103 in the desensitized area 105 as a result of heat diffusion during thermal printing.

This will now be described in more detail. A longitudinal section of the multicolor thermosensitive recording medium 101 of Embodiment 2 is shown in FIG. 7. In the multicolor thermosensitive recording medium 101 of this second embodiment, the second thermosensitive coloring layer 103 is partially formed on the first thermosensitive coloring layer 102 via the intermediate layer 106.

Before the second thermosensitive coloring layer 103 is partially coated, the function of the first thermosensitive coloring layer 102 at the location where the second thermosensitive coloring layer 103 is to be developed, is desensitized or dulled (desensitized area 105). That is, its coloring function is reduced so that it does not develop, even if heat which would develop this first thermosensitive coloring layer 102 is applied to the first thermosensitive coloring layer 102 at a location where the second thermosensitive coloring layer 103 is made to color. Thus, the intermediate layer 106 comprising resin or the like is first applied, and the second thermosensitive coloring layer 103 is coated partially thereon to obtain the thermosensitive recording medium 101.

Hereafter, this will be described in more detail.

As the first thermosensitive coloring layer 102 of this second embodiment, a thermosensitive recording medium comprising a substrate in one piece known in the art, thermosensitive paper (PD152R: black coloring) from Oji Paper Co. was used.

A desensitizing agent was applied to the part (desensitized area 105) where the second thermosensitive coloring layer 103 was to be formed to reduce the coloring function of the first thermosensitive coloring layer 102. The following coating liquid was prepared using 2-methyl piperazine as desensitizing agent, and this was partially coated and impregnated by flexographic printing to form the desensitized area 105.

(Erasing Agent Ink)

Sanpren IB-F370 (Sanyo Chemicals)—15% solution—80 weight parts

2-methyl piperazine (desensitizing agent)—20 weight parts.

Next, an overcoat resin was applied on the desensitized area 105 to form the intermediate layer 106. The overcoat resin was partially coated by flexographic printing, using a UV curing resin made by T&K TOKA (FLX-UV OP varnish). After coating, this was cured in a UV irradiation device to form the intermediate layer 106 of 2 μm thickness.

The second thermosensitive coloring layer 103 was applied over these layers. The second thermosensitive coloring layer 103 was prepared by blending the following components. For the developing color, a blue leuco dye different from the black of the first thermosensitive coloring layer 102 was used.

leuco dye-CLV—1 weight parts (Chukyo Oils and Fats, Y-CVL)

developer-D8—3 weight parts (Chukyo Oils and Fats, F-647),

sensitizer—2 weight parts (Chukyo Oils and Fats, Hydrin D-757)

lubricant—0.7 weight parts (Chukyo Oils and Fats, Hydrin Z-7-30)

coloring inhibitor—0.3 weight parts (Chukyo Oils and Fats, Hydrin D-337)

aluminum hydroxide—1 weight part,

PVA 10% solution—2 weight parts (Kuraray Co., PVA117),

water—22 weight parts.

The above mixture was partially coated to a dry weight of 8 g/m² by a diecoater to form the second thermosensitive coloring layer 103, and this was cut to the size of the form shown in FIG. 1 to obtain the multicolor thermosensitive recording medium 101. Pre-printing may also be performed by flexographic or offset printing, etc., and a protective layer may be provided on the multicolor thermosensitive recording medium 101 if necessary. The multicolor thermosensitive recording medium 101 thus obtained was printed at 0.4 mJ/dot in black and blue, using a thermal printing head from Kyocera Corp. No color mixing at all was observed in the part under the blue of the second thermosensitive coloring layer 102. Thus, by forming the intermediate layer 106, the movement of the developer of the second thermosensitive coloring layer 103 into the desensitized area 105 can be completely prevented, hence color mixing can be completely prevented.

[Embodiment 3]

Another embodiment of the present invention will now be described as Embodiment 3 with reference to FIG. 8. In the description of Embodiment 3 of the present invention, the same symbols are used to denote identical components to those of Embodiment 1, and a detailed explanation of common technical features is omitted.

FIG. 8 is a longitudinal section showing the multicolor thermosensitive recording medium 101 according to Embodiment 3 of the present invention. As the first thermosensitive coloring layer 102, a thermosensitive recording material may be used comprising a leuco dye+developer known in the art. The second thermosensitive coloring layer 103 may for example be a thermosensitive material comprising a leuco dye+developer.

An erasing agent-containing layer 107 is in contact with the first thermosensitive coloring layer 102, and is a layer which contains a dispersion or solution of an erasing agent in a vehicle which prevents the leuco dye and developer of the first thermosensitive coloring layer 102 from coloring due to heat, or erases the color. It may also contain a dispersion of microcapsules containing the erasing agent. A diffusion preventing layer 108 which prevents the erasing agent in the erasing agent-containing layer 107 from diffusing into the second thermosensitive coloring layer 103, is also formed between the erasing agent-containing layer 107, and second thermosensitive coloring layer 103.

Regarding the erasing agent-containing layer 107, it is important that the erasing agent diffuses into the first thermosensitive coloring layer 102 and prevents coloration of the first thermosensitive coloring layer 102 at least when the second thermosensitive coloring layer 103 is being colored. The erasing agent-containing layer 107 used in this third embodiment is a layer wherein the erasing agent is contained or dispersed in a vehicle having a melting point lower than the coloring temperature of the second thermosensitive coloring layer, or a layer of a material wherein a vehicle which itself has erasing properties is dispersed in a binder resin.

The erasing agent must be varied according to the leuco dye or developer, for example an agent obtained by dissolving cholic acid in polyethylene glycol, polypropylene glycol and their derivatives, or straight-chain alcohols.

Some specific examples will now be described.

(1) Erasing Agent-Containing Layer (Composition as Follows):

| | |
|---|---|
| erasing agent: polyethylene glycol #4000 | 10 weight parts |
| stabilizer: cholic acid | 1 weight part |
| extender: SiO₂ (E-2, Tatsumori Co.) | 1 weight part |
| binder resin: PVA 10% aqueous solution | 100 weight parts |
| water: | 80 weight parts |

(2) Erasing Agent Dispersion Preventing Layer (Composition as Follows):

| | |
|---|---|
| binder resin: PVA 10% aqueous solution | 10 weight parts |
| water: | 10 weight parts |

The above liquid (1) is coated in stripes to a dry coating weight of 5 g/m² by diecoating to form the erasing agent-containing layer 107. The above liquid (2) is then coated on the erasing agent-containing layer 107 to a dry coating weight of 2 g/m² by gravure printing to form the diffusion preventing layer 108.

For the second thermosensitive coloring layer 103, the materials of Embodiments 1 and 2 of the invention may be used without modification. These are as follows:

(1) Leuco Dye and Sensitizer Liquid Dispersion (Composition as Follows):

RED-40 (Yamamoto Chemicals)—2.7 weight parts,

p-benzyl phenyl (PBBP)—2 weight parts,

PVA 10% solution—30 weight parts

water—40 weight parts.

(2) Developer Liquid Dispersion (Composition as Follows):

bisphenol A—6 weight parts,

oxidized starch—2 weight parts,

calcium carbide—2 weight parts,

PVA 10% solution—30 weight parts,

water—40 weight parts.

A mixture of the above (1) and (2) was coated in stripes to a dry weight of 8 g/m² by a diecoater on the diffusion preventing layer 108, and this was cut to the size of the form to obtain the multicolor thermosensitive recording medium 101. Characters were then printed by flexographic or offset printing. A protective layer may be provided as necessary before cutting the multicolor thermosensitive recording medium 101 obtained to the size of the form.

The multicolor thermosensitive recording medium 101 thus obtained was then printed by supplying an identical energy of 0.35 mJ/dot to the second thermosensitive coloring layer 103 and first thermosensitive coloring layer 102. When the second thermosensitive coloring layer 103 is the parcel delivery service form shown in FIG. 1, in the case of a C.O.D form where payment is marked in red, for example, the second thermosensitive coloring layer 103 is colored by an energy of 0.35 mJ/dot. In this case, polyethylene glycol with a melting point of 55° C. dissolves and diffuses in the first thermosensitive coloring layer 102 together with cholic acid, so the black of the first thermosensitive coloring layer 102 does not develop (the coloring temperature of the second thermosensitive coloring layer 103 is approx. 80° C. or higher, so the temperature at which polyethylene glycol dissolves is lower than the temperature which develops the second thermosensitive coloring layer 103).

If the drying temperature when the erasing agent-containing layer 107 is coated, is set above the melting point of polyethylene glycol, it is possible to stop coloration even if the medium is heated from the beginning. However, polyethylene glycol also has a high affinity for water, and its retention properties were improved by adding cholic acid. Specifically, the cholic acid dissolved in the polyethylene glycol bonds to the developer, so retention stability is good. Here, the erasing agent which dissolves out is blocked by the diffusion preventing layer 108, and the color of the second thermosensitive coloring layer 103 is not erased.

According to the multicolor thermosensitive medium 101 described above, plural forms can be manufactured from one form.

[Embodiment 4]

Another embodiment of the present invention will now be described as Embodiment 4. In the description of Embodiment 4, reference may be made to FIG. 2 and FIG. 7.

In the description of Embodiment 4 of the present invention, identical components to those of Embodiment 1 of the invention are assigned identical symbols, and a detailed description of common technical features is omitted.

The difference of the multicolor thermosensitive recording medium 101 of Embodiment 4 of the present invention from Embodiment 1 of the invention, is that the coloration start temperature of the second thermosensitive coloring layer 103 is set to a higher temperature than the coloration start temperature of the first thermosensitive coloring layer 102

Describing this in more detail, the first thermosensitive coloring layer 102 was prepared by mixing the following liquid dispersions (1) and (2).

(1) Leuco Dye and Sensitizer Liquid Dispersion (Composition as Follows):

ODB-2 (Yamamoto Chemicals)—2 weight parts,

p-benzyl phenyl (PBBP)—2 weight parts,

PVA 10% solution—30 weight parts

water—40 weight parts.

(2) Developer Liquid Dispersion (Composition as Follows):

bisphenol A—6 weight parts,

oxidized starch—2 weight parts,

calcium carbide—2 weight parts,

PVA 10% solution—30 weight parts,

water—40 weight parts.

The first thermosensitive coloring layer 102 prepared as described above was coated on the surface of high quality paper (50 g/m²) which was the substrate using a wire bar, dried, and processed by a calender to give the first thermosensitive coloring layer 102 having an adhesion weight of 5 g/m².

Next, the erasing agent was coated on the first thermosensitive coloring layer 102. The erasing agent was polyethylene glycol #4000 (reagent) having a melting point of 55° C., and partially coated by diecoating after melting by heat. In this process, the high quality paper was heated to 60° C., the paper returned to room temperature after verifying that the agent had permeated the paper, and the polyethylene glycol remaining on the paper removed to form the desensitized area 105.

The second thermosensitive coloring layer 103, obtained by dispersing the following components (1),(2),(3) for 12 hours in a ball mill, and mixing the resulting liquid dispersions (1),(2),(3), was then coated on the paper.

(1) Leuco Dye Liquid Dispersion

RED-40 (Yamamoto Chemicals)—2.7 weight parts,

polyvinyl alcohol (PVA) 10% solution—30 weight parts

water

(2) Developer Liquid Dispersion

bisphenol A—6 weight parts,

oxidized starch—2 weight parts,

calcium carbonate—2 weight parts,

PVA 10% solution—30 weight parts

(3) Water—40 Weight Parts.

The above mixture was partially coated in stripes to a dry weight of 8 g/m² by a diecoater, and the product cut to the size of the form to obtain the multicolor thermosensitive recording medium 101. Character information was then printed by flexographic or offset printing. A protective layer may also be formed on the multicolor thermosensitive recording medium 101 thus obtained if necessary. The first thermosensitive coloring layer 102 of the multicolor thermosensitive recording medium 101 manufactured as described above was then printed black at 0.3 mJ/dot and printed red at 0.6 mJ/dot, using a thermal printing head from Kyocera Corp. Almost no color mixing was observed in parts under the red color in the second thermosensitive coloring layer 103.

From this multicolor thermosensitive recording medium 101, plural forms which differ in visual aspect may be obtained in the case where the second thermosensitive coloring layer 103 is not printed, and the case where it is printed, by the thermal head. For example, in the case of payment by sender, the red color of the second thermosensitive coloring layer 103 is developed in lines, and required items are also printed on the thermosensitive coloring layer 102. In the case of C.O.D., required items are printed on the first thermosensitive coloring layer 102 without applying energy to the second thermosensitive coloring layer 103. In this way, plural forms can be printed in different colors from one of the multicolor thermosensitive recording media 101, so plural forms can be manufactured which can be distinguished at a glance.

[Embodiment 5]

Another embodiment of the present invention will now be described as Embodiment 5. In Embodiment 5, reference will be made to FIG. 7.

In Embodiment 4 of the present invention, when the color of the second thermosensitive coloring layer 103 is developed, there is an inconsequential degree of color mixing, but in this fifth embodiment, to eliminate this completely, the intermediate layer 106 is formed between the first thermosensitive coloring layer 102 and the second thermosensitive coloring layer 103. This color mixing is due to penetration of developer in the desensitized area 105 when the second thermosensitive coloring layer 103 is applied, and to penetration of developer of the second thermosensitive coloring layer 103 in the desensitized area 105 as a result of heat diffusion during thermal printing.

As in the case of the second embodiment, the intermediate layer 106 of this embodiment is formed by coating an overcoat resin on the desensitized area 105. The overcoat resin was partially coated by flexographic printing, using a UV curing resin made by T&K TOKA (FLX-UV OP varnish). After coating, this was cured in a UV irradiation device to form the intermediate layer 106 of 2 μm thickness. The desensitizing of the first thermosensitive coloring layer 102 and second thermosensitive coloring layer 103 by the erasing agent, and the pre-printing 104, are identical to those of the fourth embodiment.

When the multicolor thermosensitive recording medium 101 comprising this intermediate layer 106 was printed under the same conditions as those of the fourth embodiment, plural forms were successfully printed from one of the multicolor thermosensitive recording media 101 without any color mixing between the first thermosensitive coloring layer 102 and second thermosensitive coloring layer 103.

[Embodiment 6]

Another embodiment of the present invention will now be described as Embodiment 6. In Embodiment 6, reference will be made to FIG. 8.

In Embodiment 6, in the multicolor thermosensitive recording medium 101 of the fourth embodiment, instead of desensitizing using an erasing agent, the erasing agent-containing layer 107 and erasing agent diffusion preventing layer 108 are formed as in the case of the third embodiment between the first thermosensitive coloring layer 102 and second thermosensitive coloring layer 103.

The erasing agent-containing layer 107 is in contact with the first thermosensitive coloring layer 102, and is a layer which contains a dispersion or solution of an erasing agent in a vehicle which prevents the leuco dye and developer of the first thermosensitive coloring layer 102 from coloring due to heat, or erases the color. It may also be a layer in which microcapsules containing the erasing agent have been dispersed. The diffusion preventing layer 108 which prevents the erasing agent in the erasing agent-containing layer 107 from diffusing into the second thermosensitive coloring layer 103, is also formed between the erasing agent-containing layer 107 and second thermosensitive coloring layer 103. Apart from this, the first thermosensitive coloring layer 102, second thermosensitive coloring layer 103 and pre-printing 104 are identical to those of the fourth embodiment.

The first thermosensitive coloring layer 102 of the multicolor thermosensitive recording medium 101 manufactured as described above was printed black at 0.3 mJ/dot and printed red at 0.6 mJ/dot, using a thermal printing head from Kyocera Corp. Almost no color mixing was observed in parts under the red color in the second thermosensitive coloring layer 103.

[Embodiment 7]

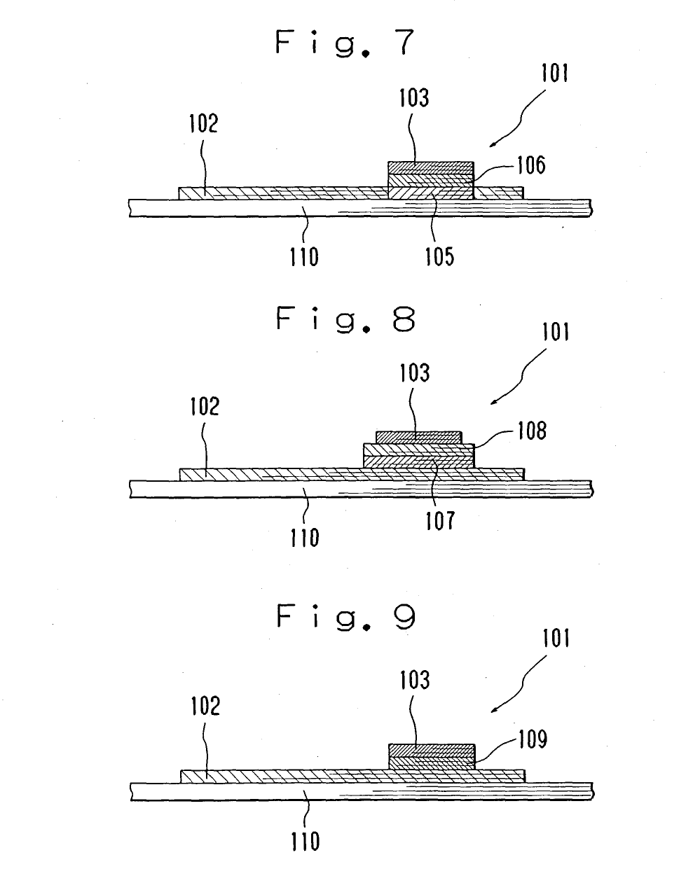

Another embodiment of the present invention will now be described as Embodiment 7 with reference to FIG. 9.

FIG. 9 is a longitudinal section of the multicolor thermosensitive recording medium of Embodiment 7 of the present invention. In the description of Embodiment 7 of the present invention, identical components to those of Embodiment 1 of the invention are assigned identical symbols, and a detailed description of common technical features is omitted. The difference of the multicolor thermosensitive recording medium 101 of Embodiment 7 of the present invention from Embodiment 1 of the invention, is that the coloration start temperature of the second thermosensitive coloring layer 103 is set to a lower temperature than the coloration start temperature of the first thermosensitive coloring layer 102.

Specifically, the first thermosensitive coloring layer 102 was prepared by dispersing the following components (1) and (2) for 12 hours in a ball mill, and mixing the resulting liquid dispersions.

(1) Leuco Dye Liquid Dispersion (Composition as Follows):

ODB-2 (Yamamoto Chemicals)—2 weight parts,

polyvinyl alcohol (PVA) 10% solution—30 weight parts

water

(2) Developer Liquid Dispersion (Composition as Follows):

bisphenol A—6 weight parts,

oxidized starch—2 weight parts,

calcium carbonate—2 weight parts,

PVA 10% solution—30 weight parts

water—40 weight parts.

After coating the above mixture on the surface of a high-quality paper (50 g/m²) using a wire bar, and drying, it was processed by a calender to give the first thermosensitive coloring layer 102 having an adhesion weight of 5 g/m².

A heat insulation layer 109 was then formed in the area where the color of the second thermosensitive film 103 was developed.

The heat insulation layer 109 was formed with an identical or larger width than that of the second thermosensitive film 103 by diecoating. In a specific example of this, the following liquid dispersion (1) was coated in stripes to a dry weight of 20 g/m² by diecoating.

(1) Heat Insulation Layer Liquid Dispersion (Composition as Follows):

extender (heat diffusion)—SiO₂—3 weight parts

PVA 10% solution—30 weight parts

calcium carbonate—2 weight parts

oxidized starch—2 weight parts

water—30 weight parts

defoaming agent—0.5 weight parts

The following liquid dispersion was also prepared as the second thermosensitive coloring layer 103 formed on this layer.

(1) Leuco Dye and Sensitizer Liquid Dispersion (Composition as Follows):

RED-40—2.7 weight parts,

p-benzyl phenyl (PBBP)—2 weight parts,

PVA 10% solution—30 weight parts

water—40 weight parts.

(2) Developer Liquid Dispersion (Composition as Follows):

bisphenol A—6 weight parts,

oxidized starch—2 weight parts,

calcium carbide—2 weight parts,

PVA 10% solution—30 weight parts,

water—40 weight parts.

This mixture was coated in stripes to a dry weight of 8 g/m² by a diecoater, and the product cut to the size of the form shown in FIG. 1 to obtain the multicolor thermosensitive recording medium 101. Character pre-printing was then performed by flexographic or offset printing. A protective layer may also be formed on the multicolor thermosensitive recording medium 101 thus obtained if necessary. The first thermosensitive coloring layer 102 of this multicolor thermosensitive recording medium 101 was printed black at 0.6 mJ/dot and the second thermosensitive coloring layer 103 was printed red at 0.3 mJ/dot in the same way, using a thermal printing head from Kyocera Corp. As a result, almost no color mixing was observed in the part under the red color in the second thermosensitive coloring layer 103.

From this multicolor thermosensitive recording medium 101, plural forms may be obtained depending on whether or not the second thermosensitive coloring layer 103 is printed by the thermal head. For example, in the case of payment by sender, the red color of the second thermosensitive coloring layer 103 is developed in lines, and required items are also printed on the thermosensitive coloring layer 102. In the case of C.O.D., required items are printed on the first thermosensitive coloring layer 102 without heating the second thermosensitive coloring layer 103. In this way, plural forms can be printed in different colors from one of the multicolor thermosensitive recording media 101, so plural forms can be manufactured which can be distinguished at a glance.

[Embodiment 8]

Another embodiment of the present invention will now be described as Embodiment 8 with reference to FIG. 10.

FIG. 10 is a longitudinal section of the multicolor thermosensitive recording medium of Embodiment 8 of the present invention. In the description of Embodiment 8 of the present invention, identical components to those of Embodiment 1 of the invention are assigned identical symbols, and a detailed description of common technical features is omitted. The difference of the multicolor thermosensitive recording medium 101 of Embodiment 8 of the present invention from Embodiment 1 of the invention, is that the second thermosensitive coloring layer 103 is formed underneath the first thermosensitive coloring layer 102.

The second thermosensitive coloring layer 103 was prepared by mixing the following liquid dispersions.

(1) Leuco Dye and Sensitizer Liquid Dispersion (Composition as Follows):

RED—2.7 weight parts,

p-benzyl phenyl (PBBP)—2 weight parts,

PVA 10% solution—30 weight parts

water—40 weight parts.

(2) Developer Liquid Dispersion (Composition as Follows):

bisphenol A—6 weight parts,

oxidized starch—2 weight parts,

calcium carbide—2 weight parts,

PVA 10% solution—30 weight parts,

water—40 weight parts.

A mixture of (1) and (2) was coated in stripes to a dry weight of 8 g/m² on the substrate 110 comprising high quality paper (50 g/m²) by a diecoater, to form the second thermosensitive coloring layer 103.

Next, the first thermosensitive coloring layer 102 was formed so as to cover this second thermosensitive coloring layer 103. The first thermosensitive coloring layer 102 was prepared by dispersing the following components (1) and (2) for 12 hours in a ball mill, and mixing the resulting liquid dispersions.

(1) Leuco Dye Liquid Dispersion (Composition as Follows):

ODB-2 (Yamamoto Chemicals)—2 weight parts,

polyvinyl alcohol (PVA) 10% solution—30 weight parts

water

(2) Developer Liquid Dispersion (Composition as Follows):

bisphenol A—6 weight parts,

oxidized starch—2 weight parts,

calcium carbonate—2 weight parts,

PVA 10% solution—30 weight parts

water—40 weight parts.

After coating the mixture prepared as described above on the surface of the substrate 110 using a wire bar, and drying, it was processed by a calender to give the first thermosensitive coloring layer 102 having an adhesion weight of 5 g/m².

Next, the erasing agent was coated on the first thermosensitive film 102 to desensitize or dull the first thermosensitive film 102 formed on parts where the second thermosensitive film 103 was formed. The erasing agent was polyethylene glycol #4000 (reagent) having a melting point of 55° C., and partially coated by diecoating after melting by heat. In this process, the high quality substrate 110 was heated to 60° C., the paper returned to room temperature after verifying that the agent had permeated the paper, and the polyethylene glycol remaining on the paper removed to form the desensitized area 105.

The product was cut to the size of a form to obtain the multicolor thermosensitive recording medium 101. Character information was then printed by flexographic or offset printing. A protective layer may also be formed on the multicolor thermosensitive recording medium 101 thus obtained if necessary.

The first thermosensitive coloring layer 102 of this multicolor thermosensitive recording medium 101 was printed black at 0.6 mJ/dot and the second thermosensitive medium 103 was printed red at 0.3 mJ/dot in the same way, using a thermal printing head from Kyocera Corp. As a result, almost no color mixing was observed in the part over the red color in the second thermosensitive coloring layer 103.

In this Embodiment 8, color mixing can be prevented more completely by forming the intermediate layer 106 between the first thermosensitive coloring layer 102 and second thermosensitive coloring layer 103 using an identical UV resin to that of Embodiment 5.

[Embodiment 9]

Another embodiment of the present invention will now be described as Embodiment 9. In Embodiment 9, reference will be made to FIG. 11. In the description of Embodiment 9 of the present invention, the same symbols are used to denote identical components to those of Embodiment 8 of the invention, and a detailed explanation of common technical features is omitted. In Embodiment 9 of the present invention, as in the case of Embodiment 8, the second thermosensitive film 103 is formed underneath the first thermosensitive film 102, and instead of desensitizing using an erasing agent, the erasing agent-containing layer 107 and erasing agent diffusion preventing-layer 108 are formed as in the case of Embodiment 3 and Embodiment 6 between the first thermosensitive coloring layer 102 and second thermosensitive coloring layer 103.

The erasing agent-containing layer 107 is in contact with the first thermosensitive coloring layer 102, and is a layer which contains a dispersion or solution of an erasing agent in a vehicle which prevents the leuco dye and developer of the first thermosensitive coloring layer 102 from coloring due to heat, or erases the color. It may also be a layer in which microcapsules containing the erasing agent have been dispersed. The diffusion preventing layer 108 which prevents the erasing agent in the erasing agent-containing layer 107 from diffusing into the second thermosensitive coloring layer 103, is also formed between the erasing agent-containing layer 107 and second thermosensitive coloring layer 103. The erasing agent-containing layer 107 and erasing agent diffusion preventing layer 108 are formed in an identical way to that of Embodiment 3, and the first thermosensitive coloring layer 102 and second thermosensitive coloring layer 103 are formed in an identical way to that of Embodiment 8, so as to obtain the multicolor thermosensitive recording medium 101.

The first thermosensitive coloring layer 102 of the multicolor thermosensitive recording medium 101 manufactured as described above was printed black at 0.6 mJ/dot and printed red at 0.3 mJ/dot, using a thermal printing head from Kyocera Corp. As a result, no color mixing at all was observed in parts over the red color in the second thermosensitive coloring layer 103.

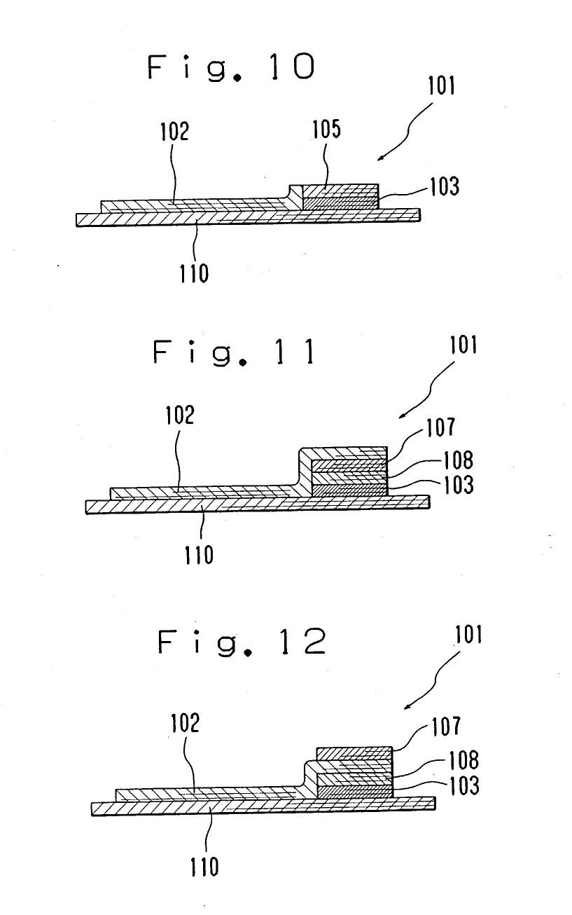

If the erasing agent-containing layer 107 is formed over the first thermosensitive coloring layer 102 as shown in FIG. 12, an identical effect is obtained.

[Embodiment 10]

Another embodiment of the present invention will now be described as Embodiment 10. In Embodiment 10, reference will be made to FIG. 13. In the description of Embodiment 10 of the present invention, the same symbols are used to denote identical components to those of Embodiment 1 of the invention, and a detailed explanation of common technical features is omitted.

In this Embodiment 10, the multicolor thermosensitive recording medium 101 is obtained wherein plural, e.g. two second thermosensitive coloring layers 103a, 103b are formed on the desensitized area 105 of the first thermosensitive coloring layer 102 by an identical method to that of Embodiment 1.

The multicolor thermosensitive recording medium 101 thus obtained was printed at 0.4 mJ/dot in black and red, using a thermal printing head from Kyocera Corp. As a result, no color mixing at all was observed underneath the red part of the second thermosensitive coloring layers 103a, 103b. Hence, the second thermosensitive coloring layer 103 may be provided with any desired color, not only at a specific location, but in any desired location.

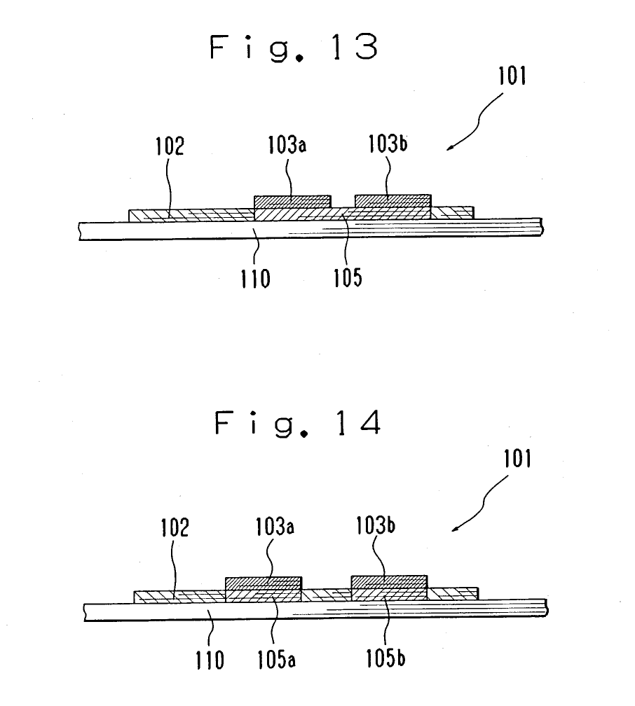

An identical effect is obtained even when desensitized areas 105a, 105b are formed independently only in areas corresponding to the second thermosensitive coloring layers 103a, 103b as shown in FIG. 14. In this case, although the method of desensitizing the desensitized areas 105a, 105b may of course be the same, a different desensitizing method may be used for the desensitized area 105a and for the desensitized area 105b. When plural second thermosensitive coloring layers 103 are provided, the developing colors of these second thermosensitive coloring layers 103 need not be the same, and they may color with different colors. In order to prevent color mixing more completely, the intermediate layer 106 can also be formed as described in Embodiments 2 and 5. Also, in this Embodiment 10, the first thermosensitive coloring layer 102 was desensitized before forming the second thermosensitive coloring layers 103a, 103b, but the invention is not limited to this arrangement, and the erasing agent-containing layer 107 and erasing agent diffusion preventing layer 108 may also be formed as in Embodiments 3 and 6.

[Embodiment 11]

Another embodiment of the present invention will now be described as Embodiment 11. In Embodiment 11, the first thermosensitive coloring layer 102 and second thermosensitive coloring layer 103 described in Embodiment 4 are used as the first thermosensitive coloring layer 102 and second thermosensitive coloring layers 103a, 103b of Embodiment 10.

The multicolor thermosensitive recording medium 101 thus obtained was printed black at 0.3 mJ/dot and printed red at 0.6 mJ/dot, using a thermal printing head from Kyocera Corp. As a result, no color mixing at all was observed in parts under the red color of the second thermosensitive coloring layers 103a, 103b. Hence, the second thermosensitive coloring layer 103 may be provided with any desired color, not only at a specific location, but in any desired location.

In the case of Embodiment 11 also, as in Embodiment 10, although the method of desensitizing the desensitized areas 105a, 105b may of course be the same, a different desensitizing method may be used for the desensitized area 105a and the desensitized area 105b. When plural second thermosensitive coloring layers 103 are provided, the developing colors of these second thermosensitive coloring layers 103 need not be the same, and they may color with different colors. In order to prevent color mixing more completely, the intermediate layer 106 can also be formed as described in Embodiments 2 and 5. Also, in Embodiment 10, the first thermosensitive coloring layer 102 was desensitized before forming the second thermosensitive coloring layers 103a, 103b, but the invention is not limited to this arrangement, and the erasing agent-containing layer 107 and erasing agent diffusion preventing layer 108 may also be formed as in Embodiments 3 and 6.

The test results from the above Embodiments 1-11 are as shown in Table 1. The two-tone coloring paper of the Comparative Example is XPD-700R from Oji Paper Co., Ltd.

TABLE 1

| | First | Second | | |
|---|---|---|---|---|
| | thermo- | thermo- | | |
| | sensitive | sensitive | Color- | |
| | coloring | coloring | mixing | Energy |
| | layer | layer | degree | control |
| Embodiment 1 | 0.4 mJ/dot | 0.4 mJ/dot | Non-color | Capable of |
| | | | mixing | printing |
| | | | | with same |
| | | | | energy |
| Embodiment 2 | 0.4 mJ/dot | 0.4 mJ/dot | Non-color | Capable of |
| | | | mixing | printing |
| | | | | with same |
| | | | | energy |
| Embodiment 3 | 0.35 mJ/dot | 0.35 mJ/dot | Non-color | Capable of |
| | | | mixing | printing |
| | | | | with same |
| | | | | energy |
| Embodiment 4 | 0.3 mJ/dot | 0.6 mJ/dot | Non-color | Not |
| | | mixing | required | |
| Embodiment 5 | 0.3 mJ/dot | 0.6 mJ/dot | Non-color | Not |
| | | | mixing | required |
| Embodiment 6 | 0.3 mJ/dot | 0.6 mJ/dot | Non-color | Not |
| | | | mixing | required |
| Embodiment 7 | 0.6 mJ/dot | 0.3 mJ/dot | Non-color | Required |
| | | | mixing | |
| Embodiment 8 | 0.6 mJ/dot | 0.3 mJ/dot | Non-color | Required |
| | | | mixing | |
| Embodiment 9 | 0.6 mJ/dot | 0.3 mJ/dot | Non-color | Required |
| | | | mixing | |
| Embodiment 10 | 0.4 mJ/dot | 0.4 mJ/dot | Non-color | Capable of |
| | | | mixing | printing |
| | | | | with same |
| | | | | energy |
| Embodiment 11 | 0.3 mJ/dot | 0.6 mJ/dot | Non-color | Required |
| | | | mixing | |
| An example | 0.65 mJ/dot | 0.35 mJ/dot | Color | |
| for | | | mixing | |
| comparison | | | around a | |
| (Two color | | | high | |
| thermo- | | | tempera- | |
| sensitive | | | ture | |
| recording | | | part | |
| medium) | | | | |

As has already been mentioned, the construction may be such that the colored leuco dye and developing agent dissolve in the layer in which they are dispersed, and develop the color of the second thermosensitive coloring layer 103 at a lower temperature than the coloration start temperature of the first thermosensitive coloring layer 102.

Further, in this description, CVL, ODB-2 and RED-40 were shown as examples of the leuco dye used in the first thermosensitive coloring layer 102 and second thermosensitive coloring layer 103, but the invention is not limited thereto, and various materials which give different color combinations of the first thermosensitive coloring layer 102 and second thermosensitive coloring layer 103, may be used.

For example, the following leuco dyes may be used as black leuco dyes:

PSD-150, PSD-184, PSD-300, PSD-802, PSD-290 (Nippon Soda), CP-101, BLACK-15, ODB, ODB-2 (Yamamoto Chemicals) BLACK-100, S-205, BLACK-305, BLACK-500 (Yamada Chemicals), TH-107 (Hodogaya Chemicals).

The Following Leuco Dyes may be Used as Blue Leuco Dyes

(These are not However Exhaustive):

BLUE-63, BLUE-502 (Yamamoto Chemicals)

BLUE-220 (Yamada Chemicals)

BLUE-3 (Hodogaya Chemicals)

The Following Leuco Dyes may be Used as Red Leuco Dyes

(These are not However Exhaustive):

PSD-HR, PSD-P, PSD-O (Nippon Soda)

Red-3, Red-40 (Yamamoto Chemicals)

Red-500, Red-520 (Yamada Chemicals)

Vermilion-DCF, Red-DCF (Hodogaya Chemicals).

Of course, blue or yellow dyes may be used, and instead of using one kind, the dyes may be mixed together.

As the developer used in the above-description, D8 and bisphenol A were given as examples, but the invention is not limited thereto, other examples being phenols, phenol metal salts, carboxylic acid metal salts, sulfonic acids, sulfonates, phosphoric acid, phosphoric acid metal salts, acid phosphate esters, acid phosphate ester metal salts, phosphorous acid and oxides of phosphorous acid metal salts, etc.

Specific examples of these are 2,4-dihydroxyacetophenone (2 4-HAP). 2,5-HAP, 2,6-HAP, 3,5-HAP, 2,3,4-HAP, 2,4-dihydroxybenzophenone (2 4-HAP), 4,4′-HBP, 2,3,4-HBP, 2,4,4′-HBP, 2,2′,4,4′-HBP, 2,3-dihydrobenzoic acid, 3,5-dihydromethylbenzoate, 4,4′-bisphenol and 2,3,4,4′-tetrahydroxybenzophenone.

The desensitizing agent is also not limited to those described in this embodiment, it being sufficient if it is able to desensitize the coloring properties of the first thermosensitive coloring layer 102, and desensitizing agents known in the art may be used. Examples are quartenary amino compounds, pyridinium salts, amines, diamines, heterocyclic compounds, aromatic amine bases, polyhydroxy compounds, alkylene oxide addition products, propylene oxides of amine compounds, and butylene oxide addition products.

The overcoat resin was a UV curing resin, but the invention is not limited thereto, and any substance may be used that can prevent movement of material from the second thermosensitive coloring layer 103 to the first thermosensitive coloring layer 102.

In this description, diecoating was given as the coating method of the second thermosensitive coloring layer 103, but the invention is not limited thereto, and it is preferred that, for coating the second thermosensitive coloring layer 103, the coating method and ink are determined by the relation of the first thermosensitive coloring layer 102. The coating must be performed without giving an adverse effect to the multicolor thermosensitive recording film 101. Moreover, in the aforethe description, the first and second thermosensitive films 102, 103 were formed by a leuco dye and developer, but various other materials which can achieve the function of the present invention may also be used. For example, in the first embodiment of the present invention, it is not necessary to use a leuco dye and developer for the second thermosensitive film 103.

In the aforethe embodiments, examples were shown where two thermosensitive coloring layers were laminated to give two colors, i.e., and black and blue, however a thermosensitive coloring layer with different coloring properties may be provided in another area, and three or more thermosensitive coloring layers laminated to give three or more colors.

In the aforethe embodiments, plural forms are manufactured from one recording medium, so manufacturing costs can be reduced. According to the embodiments of the present invention, printing can be performed without varying the coloring energy of the first thermosensitive coloring layer 102 and second thermosensitive coloring layer 103, so coloring properties can be easily controlled.

In the above embodiments, the second thermosensitive coloring layer 103 lost its color at room temperature and developed its color by heating with a thermal head, but the invention is not limited to this arrangement. In other words, the second thermosensitive coloring layer 103 may originally be colored, and made to lose its color by heating.

As a specific example, an example will be described where the electron-donating compound (leuco dye) is RED-3 (Yamamoto Chemicals), the electron receptor compound (developer) is propyl gallate, and the erasing agent is cholic acid (reagent).

First, the following leuco dye and developer were dissolved in the following volatile solvent:

Leuco dye: RED—3-1 weight part

Developer: propyl gallate—1 weight part

Volatile solvent: acetone—7 weight parts

After dissolving, the solution was mixed with the following materials.

PVA, 10% aqueous solution—30 weight parts

water—40 weight parts

oxidized starch—2 weight parts

cholic acid—10 weight parts

calcium hydroxide—2 weight parts

After mixing, the mixture was heated at 50° C. for approximately 10 minutes to evaporate the acetone, and dispersed by a paint shaker for approximately one hour to give a coating solution. Here, the second thermosensitive coloring layer 103 was applied to the first thermosensitive coloring layer 102 comprising the heat insulation layer 109, dried, and then subjected to calender processing to manufacture the multicolor thermosensitive recording medium 101.

Prior to heating, in the multicolor thermosensitive recording medium 101, only the second thermosensitive coloring layer 103 is colored. When heating is performed, due to the presence of the heat insulation layer 109, the first thermosensitive coloring layer 102 does not color, the cholic acid or developer dissolves due to the heating, the cholic acid and developer combine so that the color erasing state becomes stable, and the color of the second thermosensitive coloring layer 103 is erased. This construction also can be used to manufacture plural forms.

[Embodiment 12]

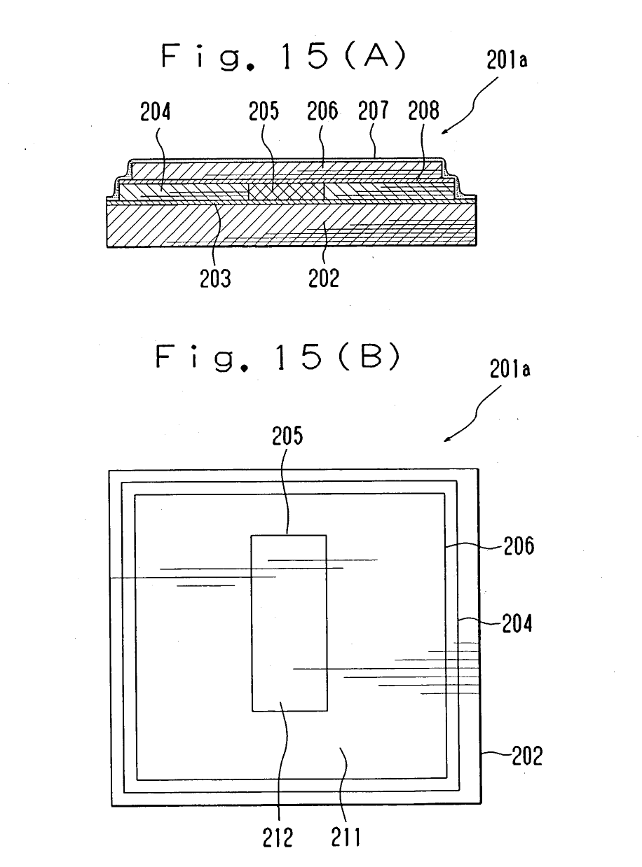

Another embodiment of the present invention will now be described as Embodiment 12 with reference to FIG. 15.

FIG. 15 shows a schematic view of a multicolor thermosensitive recording medium 201a according to Embodiment 12. FIG. 15(A) shows a cross-sectional view, and FIG. 15(B) shows a plan view. This multicolor thermosensitive recording medium 201a is a thermosensitive recording medium which can develop different colors in different parts.

High-quality paper is for example used as a substrate 202. An undercoat layer 203 comprising clay and a binder resin, and a first thermosensitive coloring layer 204, are laminated on one surface of this substrate. A desensitized region 205 which is at least desensitized or dulled with respect to the heat energy which develops the color, is partially formed on the first thermosensitive coloring layer 204. The second thermosensitive coloring layer 206 which develops a color with a different tone to that of the first thermosensitive coloring layer 204 when heat energy is applied, is laminated on this first thermosensitive coloring layer 204 comprising the desensitized region 205, and a protective layer 207 is laminated if necessary on this upper layer. This protective layer 207 is provided when the environmental conditions of use are severe.

Next, specific examples of manufacturing the aforethe multicolor thermosensitive recording medium 201a will be described, First, the first thermosensitive coloring layer 204 is applied by a roll coater to a dry film thickness of 5 um on one surface of the substrate 202 provided with the undercoat layer 203.

Composition of ink of first thermosensitive coloring layer 204

(1) Developer Liquid Dispersion

Developer: 4-hydroxy-4′-isopropoxydiphenylsulfone (F-647 from Chukyo Oils and Fats)—3 weight parts

Sensitizer: Methyl stearoamide (D757 from Chukyo Oils and Fats)—2 weight parts,

Lubricant: Zinc stearate (Z-7-30 from Chukyo Oils and Fats)—0.3 weight parts,

Inorganic pigment: Calcium carbonate—2 weight parts,

PVA117—2 weight parts (Kuraray Co., Ltd.)

Water—33 weight parts.

The above blend was dispersed by a paint shaker for 3 hours to obtain a developer liquid dispersion.

(2) Leuco Dye A, Liquid Dispersion

Leuco dye: RED-3 (Yamamoto Chemicals)—1 weight part,

PVA117 (10% solution)—2 weight parts,

Water—3 weight parts

were dispersed by a sand mill to obtain leuco dye A liquid.

(3) Leuco Dye B, Liquid Dispersion

Leuco dye: 3,6-dimethoxyfuran—1 weight part,

PVA117 (10% solution)—2 weight parts,

Water—3 weight parts

were dispersed by a sand mill to obtain a leuco dye B liquid dispersion

(4) Leuco Dye C, Liquid Dispersion

Leuco dye: CLV—1 weight part (Y-CVL from Chukyo Oils and Fats)

PVA117 (10% solution)—2 weight parts,

Water—3 weight parts

were dispersed by a paint shaker to obtain a leuco dye C liquid dispersion.

Next, after preparing the ink by mixing the leuco dye A liquid dispersion (1 weight part), leuco dye B liquid dispersion (1 weight part) and developer liquid dispersion (1 weight part) described above, the first thermosensitive coloring layer 204 was formed on the upper surface of the undercoat layer 203 formed on the substrate 202, by coating and drying.

The desensitized region 205 was partially formed on the first thermosensitive coloring layer 204 thus obtained. The position and shape of this desensitized region 205 are determined by the intended use of this multicolor thermosensitive recording medium 1.

Here, specific details will be given for forming this desensitized region 205. First, a process is performed for reducing the coloring function of a preset region in the first thermosensitive coloring layer 204. This process uses 2-methyl piperazine as desensitizing agent. The desensitized region 205 is formed by blending the following coating liquid, and impregnating the preset region described above with the liquid by flexographic printing.

(Desensitizing Agent Ink)

Sanpren IB0F370 (Sanyo Chemicals), 15% solution—80 weight parts

2-methyl piperazine (desensitizing agent)—20 weight parts.

Next, a barrier layer 208 is formed if necessary. This barrier layer 208 is provided to prevent diffusion of the desensitizing agent in the second thermosensitive coloring layer 206. This barrier layer 208 is formed by applying a 1:1 mixture of SCX-70 (Johnson Polymers) and PVA117 by a roll coater, coat drying to a dry film thickness of 2 μm and processing by a calender.

Next, a coating solution comprising the leuco dye C liquid dispersion (1 weight part) and developer liquid dispersion (1 weight part) is applied by a roll coater, and dried. The coating amount is adjusted to give a film thickness of 5 μm, thus forming the second thermosensitive coloring layer 206.

The protective layer 207 is formed if necessary by applying the following coating solution by a roll coater to a dry film thickness of 2 μm by the same method as described above. This is then subjected to calender processing to give the multicolor thermosensitive recording medium 201a.

(Ink of Protective Layer 207)

Lubricant: Zinc stearate (Z-7-30 from Chukyo Oils and Fats)—2 weight parts,

Calcium carbonate—11.2 weight parts,

PVA117—2 weight parts,

Water—22 weight parts

were dispersed by a sand mill to give the coating solution.

In the multicolor thermosensitive recording medium 201a, by choosing materials for the first thermosensitive coloring layer 204 and second thermosensitive coloring layer 206 which color by applying approximately the same thermal energy, the first thermosensitive coloring layer 204 and second thermosensitive coloring layer 206 color by applying effectively the same thermal energy. However, in the desensitized region 205, the first thermosensitive coloring layer 204 does not color, so it develops the blue color of the second thermosensitive coloring layer 206 alone (color of CLV, crystal violet lactone). Regions of other laminated parts are colored with a mixture of the colors of the first thermosensitive coloring layer 204 and second thermosensitive coloring layer 206, and turn almost black. In this mixed coloration, the whole of the heated part is colored, so color mixing does not occur only in the outline part.

Hence, the multicolor thermosensitive recording medium 201a will comprise a part wherein the laminated layers are printed in mixed colors, and a part wherein only the second thermosensitive coloring layer 204 is printed in a monochrome color.

In other words, as shown by the plan view of FIG. 15(B), the completed multicolor thermosensitive recording medium 201a comprises a thermosensitive coloring area 211 which can develop the mixed colors of the first thermosensitive coloring layer 204 and second thermosensitive coloring layer 206, and a thermosensitive coloring area 212 which can develop only the color of the second thermosensitive coloring layer 206.

According to this embodiment, unlike the case of the multicolor thermosensitive recording paper of the prior art, different regions of arbitrarily set printing regions can be printed with different colors without applying very different thermal energies to develop two colors. Here, if the coloring temperature of the first thermosensitive coloring layer 204 is α and the coloring temperature of the second thermosensitive coloring layer 206 is β, materials were used satisfying the relation α=β, however it is sufficient if at least the relation α≦β is satisfied, and the lower first thermosensitive coloring layer 204 can be colored simultaneously when the upper second thermosensitive coloring layer 206 is colored.

The above embodiment was described in the case where a leuco dye was used, but the invention is not limited to this arrangement, and regarding the mixed colors of the first thermosensitive coloring layer 204 and second thermosensitive coloring layer 206, or the monochrome coloring of the second thermosensitive coloring layer 206, thermosensitive recording materials which give desired colors may be suitably selected.

For example, regarding the blue leuco dyes used in the second thermosensitive coloring layer 206, CLV, BLMB (Yamamoto Soda), BLUE-63, BLUE-502 (Yamamoto Chemicals), BLUE-220 (Yamaoka Chemicals) or BLUE-3 (Hodogaya Chemicals) may be used.

The following are examples of the leuco dye used in the first thermosensitive coloring layer 204.

Leuco dye A: red (magenta) pigments can be used. For example, PSD-HR, PSD-P (Nippon Soda), RED-500, RED-520 (Yamada Chemicals), RED-DCF (Hodogaya Chemicals), RED-3, RED-40 and Y-1 (Yamamoto Chemicals) may be used.

Leuco dye B: yellow leuco dyes such as 3,6-dimethoxyfuroran, and 1-(4-n-dodecyloxy-3-methoxyphenyl)-2-(2-quinolyl)ethylene may be used.

When the tone of the second thermosensitive coloring layer 206 is changed, for example when a red pigment is used, a blue pigment may be used as the leuco dye A of the first thermosensitive coloring layer 204. Any desired color tone may be obtained by using one or more of these leuco dyes.

It is not necessary that the color representing the mixed color from the first thermosensitive coloring layer 204 and second thermosensitive coloring layer 206, is black, and the leuco dyes used for the first thermosensitive coloring layer 204 and second thermosensitive coloring layer 206 may be selected from the color which is finally required.

The case was described where the developer of this embodiment was 4-hydroxy-4′-isopropoxydiphenylsulfone, but the invention is not limited to this arrangement, and phenols, phenol metal salts, carboxylic acid metal salts, sulfonic acids, sulfonates, phosphoric acids, phosphoric acid metal salts, acid phosphates, acid phosphate metal salts. phosphorous acid and oxides of phosphorous acid metal salts, can also be used.

For example, bisphenol A, 2,4-dihydroxyacetophenone (2,4-HAP), 2,5-HAP, 2,6-HAP, 3,5-HAP, 2,3,4-HAP, 2,4-dihydroxybenzophenone (2 4-HBP), 4,4′-HBP, 2,3,4-HBP, 2,4,4′-HBP, 2,2′,4,4′ HBP, 2,3-dihydrobenzoic acid, 3,5-dihydromethylbenzoate, 4,4′-bisphenol and 2,3,4,4′-tetrahydroxy benzophenone can be used.

The developer used in the first thermosensitive coloring layer 204 depends on its mutual interaction with the desensitizing agent, and it must therefore be selected according to the desensitizing agent used. Although 2-methyl piperazine was used for the desensitizing agent of this embodiment, the invention is not limited thereto, and thermoplastic polyethers, polyethylene imines, stearyl alcohols, polyethylene glycols, etc., may also be used provided that they can prevent coloration of the first thermosensitive coloring layer 204.

It is possible to dispense with the barrier layer 208 by using a combination of a desensitizing agent and developer, wherein the desensitizing agent reacts with the developer of the first thermosensitive coloring layer 204 to desensitize it, but does not react with the developer of the second thermosensitive coloring layer 206. The protective layer 207 is of course not necessary when durability is not required.

In the above description, an example was described where plural first thermosensitive coloring layers 204 were formed on the substrate 202, however a thermosensitive coloring paper wherein a thermosensitive coloring layer (first thermosensitive coloring layer) is already laminated on the substrate may also be used. If this solution is adopted, the step for laminating the first thermosensitive coloring layer may be omitted.

[Embodiment 13]

Another embodiment of the present invention will now be described as Embodiment 13 with reference to FIG. 15.

Embodiment 13 of the present invention has the same composition and construction as Embodiment 1 of the invention, and will be described referring to FIG. 15, but it is different from Embodiment 1 in that a black leuco dye is used for the first thermosensitive coloring layer 204. Specifically, a black leuco dye is used as the leuco dye A of Embodiment 1. Also, the leuco dye B is absent. The leuco dye C used for the second thermosensitive coloring layer 206 is identical to that of Embodiment 1.

The amount of leuco dye added for the first thermosensitive coloring layer 204 must be either greater than the amount of leuco dye used for the second thermosensitive coloring layer 206, or the coating film thickness must be made thicker (or both). Hence, the second thermosensitive coloring layer 206 is rendered indistinguishable by the coloration of the first thermosensitive coloring layer 204 when parts other than the desensitized region are heated.

For example, the leuco dye of the second thermosensitive coloring layer 206 is blended in a proportion of 1 weight part to 5 weight parts of ODB-2 (Yamamoto Chemicals) in the leuco dye of the first thermosensitive coloring layer 204. The amount of sensitizer and developer in the developer liquid dispersion must be adjusted in accordance with the amount of leuco dye.

More specifically,

<First Thermosensitive Coloring Layer 204>

(1) Developer Liquid Dispersion A

Developer: 4-hydroxy-4′-isopropoxydiphenylsulfone (F-647 from Chukyo Oils and Fats)—10 weight parts,

Sensitizer: Methyl stearoamide (D-757 from Chukyo Oils and Fats)—5 weight parts,

Lubricant: Zinc stearate (Z 7-30 by Chukyo Oils and Fats)—1 weight part,

Inorganic pigment: Calcium carbonate—2 weight parts,

PVA117—3 weight parts (Kuraray Co., Ltd.)

Water—50 weight parts.

The above mixture was dispersed in a paint shaker for 3 hours to obtain a developer liquid dispersion

(2) Leuco Dye A Liquid Dispersion

Leuco dye: ODB-2 (Yamamoto Chemicals)—5 weight parts,

PVA117 (10% solution)—5 weight parts,

Water—15 weight parts

were dispersed by a sand mill to obtain leuco dye liquid A.

The above liquid dispersions were mixed in a 1:1 ratio, and coated/dried to give a dry film thickness of 7 μm by a roll coater.

After coating the first thermosensitive coloring layer 204, the desensitized region 205 was formed by flexographic printing as in the case of Embodiment 1. Furthermore, calender processing was performed after forming the barrier layer 208, and the second thermosensitive coloring layer 206 was laminated as in the case of Embodiment 1.

<Second Thermosensitive Coloring Layer 206>

(3) Developer Liquid Dispersion

Developer: 4-hydroxy-4′-isopropoxydiphenyl sulfone (F-647 from Chukyo Oils and Fats)—3 weight parts,

Sensitizer: Methyl stearoamide (D-757 from Chukyo Oils and Fats)—2 weight parts,

Lubricant: Zinc stearate (Z-7-30 from Chukyo Oils and Fats)—0.3 weight parts,

Inorganic pigment: Calcium carbonate—2 weight parts,

PVA117—2 weight parts (Kuraray Co.,)

Water—33 weight parts.

The above mixture was dispersed in a paint shaker 3 hours to obtain a developer liquid dispersion.

(4) Leuco Dye C Liquid Dispersion:

Leuco dye-CVL—1 weight part (Y-CVL from Chukyo Oils and Fats)

PVA117 (10% solution)—2 weight parts,

Water—3 weight parts.

The above liquid dispersion was applied by a roll coater to form a coating layer, and then dried to form the second thermosensitive coloring layer 206 (as in the case of Embodiment 1). The protective layer 207 was then formed to obtain the multicolor thermosensitive recording medium 1, as in the case of Embodiment 1. A multicolor thermosensitive recording medium 1b thus obtained offers identical advantages to those of Embodiment 1.

The second thermosensitive coloring layer 206 is not limited to blue, and a red pigment may be used as in the case of Embodiment 1.

In both Embodiments 1, 2, the test shown in Table 1 was performed by a Toshiba Tech Label Printer KP-50. The blue color in the printing results in Table 2 means a blue color on the desensitized region 205.

TABLE 2

| | KP-50 density setting | | Printing result | | Color- |
|---|---|---|---|---|---|
| | Black | Blue | Black | Blue | mixing |
| | coloration | coloration | coloration | coloration | state |
| Embodi- | −5 | −5 | good | good | not |
| ment | | | | | verifi- |
| 1 | | | | | able |
| Embodi- | −2 | −2 | good | good | not |
| ment | | | | | verifi- |
| 2 | | | | | able |

[Embodiment 14]

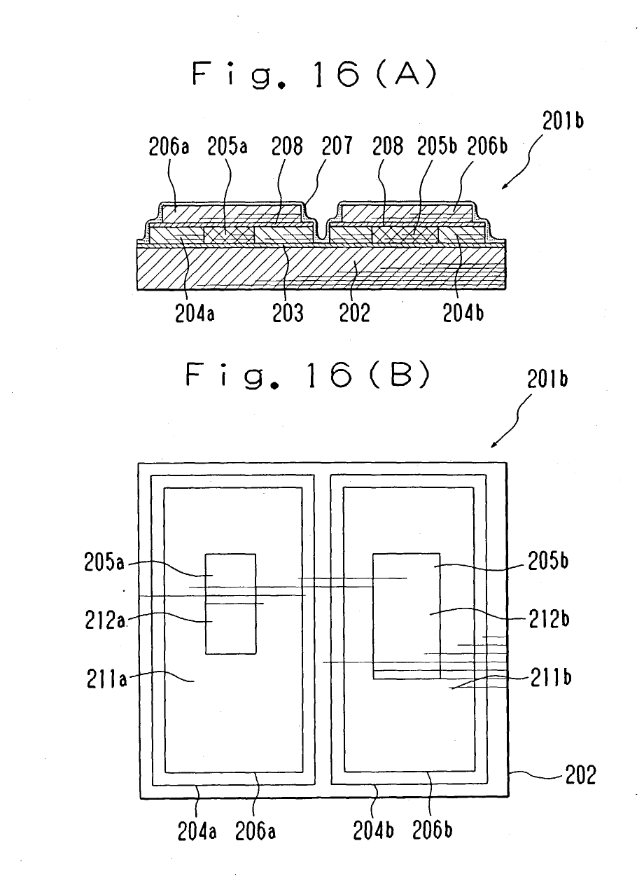

Another embodiment of the present invention will now be described as Embodiment 14 with reference to FIG. 16.

FIG. 16 shows a schematic view of the multicolor thermosensitive recording medium 1b which is Embodiment 14 of the present invention. FIG. 16(A) is a cross-sectional view, and FIG. 16(B) is a plan view of same. The same symbols are used to denote identical components to those of Embodiment 1, 2, and a detailed explanation of common technical features is omitted (same in following embodiments).

In the multicolor thermosensitive recording medium 1b of Embodiment 14, another first thermosensitive coloring layer 204b is formed in any region different from the first thermosensitive coloring layer 204a on the undercoat layer 203 formed on the substrate 202. Next, the desensitized regions 205a, 205b are formed on the thermosensitive coloring layers 204a, 204b. Further, the barrier layer 208 and second thermosensitive coloring layers 206a, 206b are formed on the upper layers of these. Subsequently, the multicolor thermosensitive recording medium 1b on which the protective layer 207 is formed, is obtained. Thus, the first thermosensitive coloring layers 204a, 204b, and the second thermosensitive coloring layers 206a, 206b, are formed in different regions on the substrate 202.

According to the multicolor thermosensitive recording medium 1b having the above construction, a thermosensitive coloring area 211a can be printed in a mixed color of the laminate of the first thermosensitive coloring layer 204a and second thermosensitive coloring layer 206a, while a thermosensitive coloring area 212a can be printed in a single color of the second thermosensitive coloring layer 206a. Likewise, a thermosensitive coloring area 211b can be printed in a mixed color of the laminate of the first thermosensitive coloring layer 204b and second thermosensitive coloring layer 206b, while a thermosensitive coloring area 212b can be printed in a single color of the second thermosensitive coloring layer 206b. For example, a leuco dye which colors magenta and yellow may be used for the first thermosensitive coloring layer 204a, and a cyan type leuco dye may be used for the second thermosensitive coloring layer 206a. By so doing, the thermosensitive coloring area 211a is black, and the thermosensitive coloring area 212a is cyan color. Also, if a leuco dye which colors yellow is used for the first thermosensitive coloring layer 206b, and the same cyan leuco dye is used for the second thermosensitive coloring layer 206b as for the second thermosensitive coloring layer 206a, the thermosensitive coloring area 211b is green, and the thermosensitive coloring area 212b is cyan color. Of course, it will be understood that the invention is not limited to these combinations, and various colors may be redeveloped by varying part of the first thermosensitive coloring layer or second thermosensitive coloring layer. In particular, if the colors developed by the first thermosensitive coloring layers 204a, 204b and/or the color developed by the second thermosensitive coloring layers 206a, 206b are changed, various kinds of the multicolor thermosensitive recording medium 1b may be obtained.

[Embodiment 15]

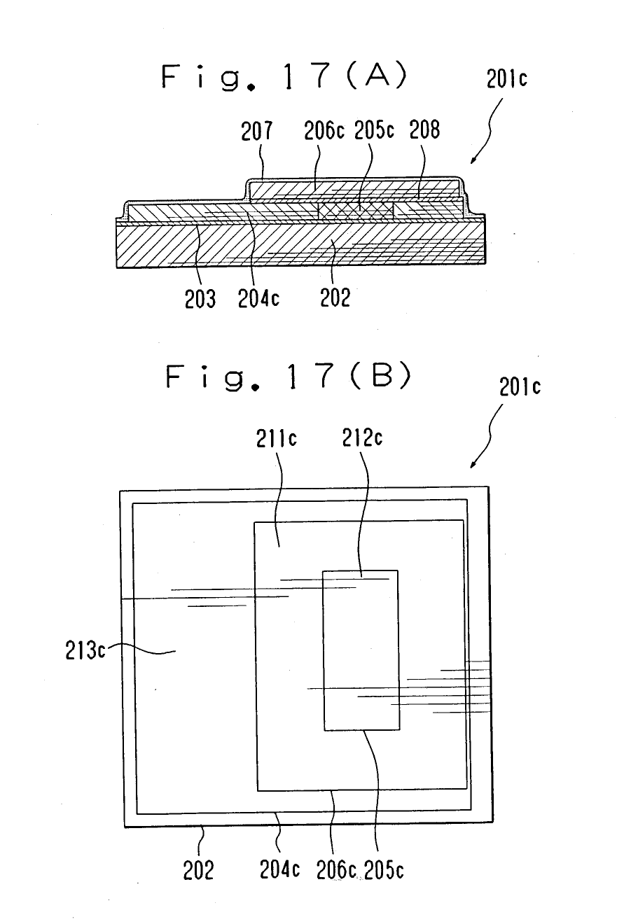

Another embodiment of the present invention will be described as Embodiment 15 with reference to FIG. 17.

FIG. 17 shows a schematic view of a multicolor thermosensitive recording medium 1c which is Embodiment 15 of the present invention. FIG. 17(A) is a cross-sectional view, and FIG. 17(B) is a plan view of same.

In the multicolor thermosensitive recording medium 1c of this Embodiment 15, firstly, a first thermosensitive coloring layer 204c is formed on the undercoat layer 203 which is formed on the substrate 202. Next, a desensitized region 205c is formed on this first thermosensitive coloring layer 204c. The barrier layer 208 and a second thermosensitive coloring layer 206c are then formed in part of the first thermosensitive coloring layer 204c. Subsequently, by forming the protective layer 207, the multicolor thermosensitive recording medium 1c is obtained. Specifically, in the aforethe embodiments, the second thermosensitive coloring layer 206 was formed over the whole surface of the first thermosensitive coloring layer 204, but in this Embodiment, the first thermosensitive coloring layer 204 contains a single layer region wherein the second thermosensitive coloring layer 206 is not laminated.

According to the multicolor thermosensitive recording medium 1c having this construction, a thermosensitive coloring area 211c can be printed in a mixed color of the laminate of the first thermosensitive coloring layer 204c and second thermosensitive coloring layer 206c, while a thermosensitive coloring area 212c can be printed in a single color of the second thermosensitive coloring layer 206c, and a thermosensitive coloring area 13c comprising only the first thermosensitive coloring layer 204c can also be printed in a single color of the first thermosensitive coloring layer 204c. For example, if a yellow leuco dye and magenta leuco dye are used for the first thermosensitive coloring layer 204c, and a cyan leuco dye is used for the second thermosensitive coloring layer 206, the thermosensitive coloring area 211c gives a black coloration, the thermosensitive coloring area 212c gives a cyan color, and the thermosensitive coloring area 13c gives a red coloration. Of course, these color combinations are not exhaustive.

[Embodiment 16]

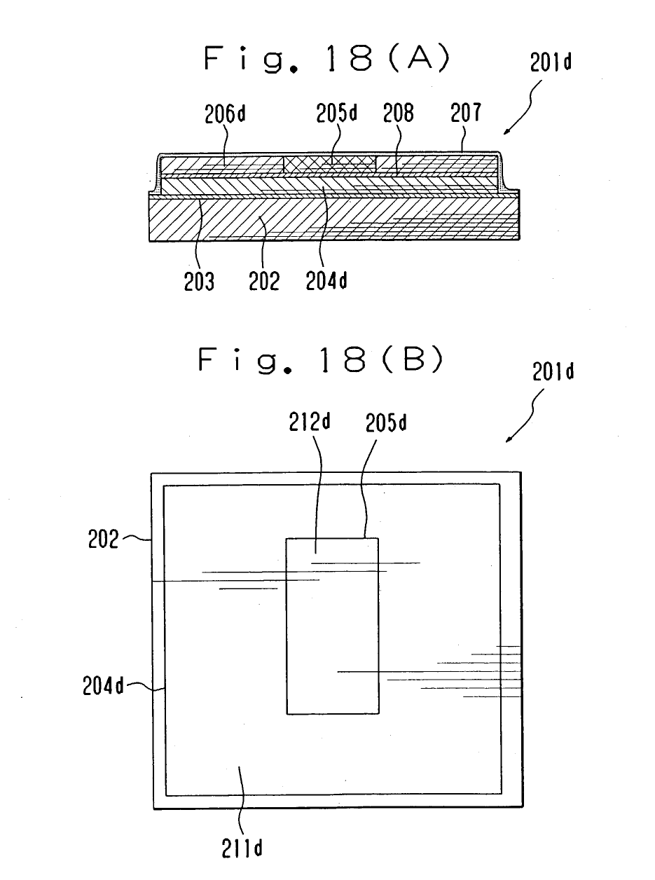

Another embodiment of the present invention will be described as Embodiment 16 with reference to FIG. 18.

FIG. 18 shows a schematic view of a multicolor thermosensitive recording medium 1d which is Embodiment 16 of the present invention. FIG. 18(A) is a cross-sectional view, and FIG. 18(B) is a plan view of same.

In this multicolor thermosensitive recording medium 1d of Embodiment 16, a first thermosensitive coloring layer 204d is formed on the surface of the substrate 202 on which the undercoat layer 203 is formed. Next, the barrier layer 208 is formed on the upper layer of the first thermosensitive coloring layer 204d. Next, a second thermosensitive coloring layer 206d is formed on the upper layer of this barrier layer 208. Processing is then performed to desensitize or dull the thermosensitive coloring function, as in the case of the aforethe embodiments, in part of this second thermosensitive coloring layer 206d, and by forming the desensitized region 205d as shown in the figure, the multicolor thermosensitive recording medium 1d is obtained.

By forming the protective layer 207 when necessary in order to cope with the environments in which this multicolor thermosensitive recording medium 1d is used, deterioration of the thermosensitive coloring layers due for example to temperature can be prevented. Further, even if the barrier layer 208 is not formed over the whole surface of the first thermosensitive coloring layer 204d, it should be formed at least in a region where the desensitized region 205d is formed. This barrier layer 208 is used to prevent the desensitizing agent from permeating the first thermosensitive coloring layer 204d, and thus reducing its thermosensitive coloring properties when the desensitized region 205d is formed. Therefore, if thermosensitive coloring properties do not have to be reduced, it is not absolutely necessary to provide the barrier layer 208. For example, if the desensitizing agent selectively has an effect only on the second thermosensitive coloring layer 206d, or if there is no concern that it will diffuse into the first thermosensitive coloring layer 204d, the barrier layer 208 may be omitted.

Referring to FIG. 18(B) which is a plan view of the multicolor thermosensitive recording medium 1d formed in this way, a thermosensitive coloring area 211d has a region corresponding to a laminate of the first thermosensitive coloring layer 204d and second thermosensitive coloring layer 206d, and when printing is performed in this thermosensitive coloring area 211d, the printing acquires the mixed color of the thermosensitive coloring layers 204d, 206d due to the applied thermal energy. Further, when thermal energy is likewise applied to a thermosensitive coloring area 212d to cause coloration, as the coloring properties of the second thermosensitive coloring layer 206d are desensitized, the printing of the first thermosensitive coloring layer 204d is monochrome.

By forming the thermosensitive coloring areas 211d, 212d in this way, different colors can be developed. If, for example, the thermosensitive coloring material of the first thermosensitive coloring layer 204d and the thermosensitive coloring material of the second thermosensitive coloring layer 206d are chosen such that they color at the same temperature, all printing regions of this multicolor thermosensitive recording member Id can be printed (colored) with the same applied energy. It will of course be understood that even if materials with different coloring temperatures are selected, all printing regions can still be printed by applying a thermal energy sufficient to color the thermosensitive coloring layer having the higher coloring temperature.

Thus, the coloring temperatures of the first thermosensitive coloring layer 204d and second thermosensitive coloring layer 206d may be arbitrarily selected.

As described above in the case of the above embodiments, according to the present invention, a multicolor thermosensitive recording medium which permits recording in different colors can be obtained by means of a simple construction. It may be noted that in embodiments which make specific use of color mixing, if the embodiment can be implemented by a method which renders the coloration of the second thermosensitive coloring layer indistinguishable when the first thermosensitive coloring layer is colored, such as was described in Embodiment 2, it will be understood to be within the scope of the present invention. For example, if the first thermosensitive coloring layer turns black and the second thermosensitive coloring layer turns blue, the mixture of black and blue is actually black, but this case shall also be construed to be within the concept of the term “color mixing” of the present invention.

The present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

The present application is based on Japanese Priority Documents 2000-077292 filed on Mar. 17, 2000, 2000-319134 filed on Oct. 19, 2000 and 2000-389344 filed on Dec. 21, 2000, the content of which are incorporated herein by reference.

What is claimed is:

1. A multicolor thermosensitive recording medium, comprising:
a substrate;
a first thermosensitive coloring layer formed on the substrate, which develops by the application of coloring energy; and
a second thermosensitive coloring layer formed on the substrate, which develops with a different color from the first thermosensitive coloring layer by the application of coloring energy;
wherein at least one of a region wherein a monochrome color of the first thermosensitive coloring layer is obtained without coloring the second thermosensitive coloring layer, and a region wherein a monochrome color of the second thermosensitive coloring layer is obtained without coloring the first thermosensitive coloring layer, is provided.

2. A multicolor thermosensitive recording medium as defined in claim 1, wherein the first thermosensitive coloring layer and the second thermosensitive coloring layer develop in different colors by the application of the same amount of coloring energy.

3. A multicolor thermosensitive recording medium as defined in claim 2, wherein the second thermosensitive coloring layer is laminated on the first thermosensitive sensitive layer, and color mixing by the coloration of the first thermosensitive coloring layer when the second thermosensitive coloring layer develops a color, is prevented.

4. A multicolor thermosensitive recording medium as defined in claim 3, wherein the color mixing is prevented by desensitizing or dulling the coloring function of the first thermosensitive coloring layer in a part where it is necessary to develop the color of the second thermosensitive coloring layer.

5. A multicolor thermosensitive recording medium as defined in claim 4, wherein the desensitizing or dulling of the coloring function of the first thermosensitive coloring layer is achieved by impregnating the first thermosensitive coloring layer with an erasing agent which causes desensitizing or dulling by bonding with a material contributing to the color of the first thermosensitive coloring layer, so as to produce the bond with the material.

6. A multicolor thermosensitive recording medium as defined in claim 3, 4 or 5, wherein an intermediate layer is provided between the first thermosensitive coloring layer and the second thermosensitive coloring layer.

7. A multicolor thermosensitive recording medium as defined in claim 3, wherein the desensitizing or dulling of the coloring function of the first thermosensitive coloring layer is achieved by an erasing agent-containing layer at least part of which contains the erasing agent which causes desensitizing or dulling by bonding with a material contributing to the color of the first thermosensitive coloring layer, the erasing agent-containing layer is a solid when not heated and dissolves when a material functioning as a vehicle is heated to a predetermined temperature, and this material or the erasing agent dispersed or dissolved therein has the desensitizing or dulling function.

8. A multicolor thermosensitive recording medium as defined in claim 7, wherein the predetermined temperature is a temperature equal to or less than the temperature at which the second thermosensitive coloring layer colors.

9. A multicolor thermosensitive recording medium as defined in claim 7 or 8, wherein a diffusion preventing layer, which prevents the vehicle or the erasing agent from diffusing into the second thermosensitive coloring layer, is formed between the second thermosensitive coloring layer and the erasing agent-containing layer.

10. A multicolor thermosensitive recording medium as defined in claim 1, wherein the first thermosensitive coloring layer and the second thermosensitive coloring layer are laminated, the second thermosensitive coloring layer is formed partially, and color mixing due to the first thermosensitive coloring layer is prevented when the color of the second thermosensitive coloring layer is developed.

11. A multicolor thermosensitive recording medium as defined in claim 10, wherein the color mixing is prevented by desensitizing or dulling the coloring function of the first thermosensitive coloring layer in a part where it is necessary to develop the color of the second thermosensitive coloring layer.

12. A multicolor thermosensitive recording medium as defined in claim 11, wherein the second thermosensitive coloring layer is laminated at least over a part where the coloring function of the first thermosensitive coloring layer is desensitized or dulled.

13. A multicolor thermosensitive recording medium as defined in claim 10, wherein the desensitizing or dulling of the coloring function of the first thermosensitive coloring layer is achieved by impregnating the first thermosensitive coloring layer with an erasing agent which causes desensitizing or dulling by bonding with a material contributing to the color of the first thermosensitive coloring layer, so as to produce the bond with the material.

14. A multicolor thermosensitive recording medium as defined in claim 10, 11, 12 or 13, wherein an intermediate layer is provided between the first thermosensitive coloring layer and the second thermosensitive coloring layer.

15. A multicolor thermosensitive recording medium as defined in claim 10, wherein the desensitizing or dulling of the coloring function of the first thermosensitive coloring layer is achieved by an erasing agent-containing layer at least part of which contains the erasing agent which causes desensitizing or dulling by bonding with a material contributing to the color of the first thermosensitive coloring layer, the erasing agent-containing layer is a solid when not heated and dissolves when a material functioning as a vehicle is heated to a predetermined temperature, and this material or the erasing agent dispersed or dissolved therein has the desensitizing or dulling function.

16. A multicolor thermosensitive recording medium as defined in claim 15, wherein the predetermined temperature is a temperature equal to or less than the temperature at which the second thermosensitive coloring layer colors.

17. A multicolor thermosensitive recording medium as defined in claim 15 or 16, wherein a diffusion preventing layer, which prevents the vehicle or the erasing agent from diffusing into the second thermosensitive coloring layer, is formed between the second thermosensitive coloring layer and the erasing agent-containing layer.

18. A multicolor thermosensitive recording medium as defined in claim 10, wherein the coloring temperature of the second thermosensitive coloring layer is less than the coloring temperature of the first thermosensitive coloring layer, the second thermosensitive coloring layer is laminated over the first thermosensitive coloring layer, and the color mixing is prevented by a heat insulation layer formed between the first thermosensitive coloring layer and the second thermosensitive coloring layer so as to insulate the two thermosensitive coloring layers.

19. A multicolor thermosensitive recording medium as defined in claim 1, wherein the second thermosensitive coloring layer is striped.

20. A multicolor thermosensitive recording medium as defined in claim 1, wherein plural second thermosensitive coloring layers which develop in plural colors different from that of the first thermosensitive coloring layer, are formed on the substrate.

21. A multicolor thermosensitive recording medium as defined in claim 1, wherein a region where color mixing between the first thermosensitive coloring layer and the second thermosensitive coloring layer is obtained by applying coloring energy, is provided in a printing region.

22. A multicolor thermosensitive recording medium as defined in claim 21, wherein a desensitized region is formed in the first thermosensitive coloring layer which desensitizes or dulls the coloring function in part thereof, and the region in which the color mixing of the first thermosensitive coloring layer and the second thermosensitive coloring layer is obtained, is formed by a part of the second thermosensitive coloring layer covering the first thermosensitive coloring layer over a wider region than the desensitized region.

23. A multicolor thermosensitive recording medium as defined in claim 22, wherein the first thermosensitive coloring layer develops a color when the laminated second thermosensitive coloring layer develops a color.

24. A multicolor thermosensitive recording medium as defined in claim 22 or 23, wherein the thermosensitive coloring layers are formed such that, when the coloring temperature of the first thermosensitive coloring layer is α, and coloring temperature of the second thermosensitive coloring layer is β, the relation α≦β is satisfied.

25. A multicolor thermosensitive recording medium as defined in claim 21, wherein the second thermosensitive coloring layer is laminated over the first thermosensitive coloring layer, and part thereof comprises a desensitized region which desensitizes or dulls the coloring function.

26. A multicolor thermosensitive recording medium as defined in claim 21, wherein plural first thermosensitive coloring layers and second thermosensitive coloring layers are formed in different regions on the substrate, and in the different regions, the colors developed by at least one of the first thermosensitive coloring layers and the second thermosensitive coloring layers are different.

27. A multicolor thermosensitive recording medium as defined in claim 21, wherein the first thermosensitive coloring layer comprises a region wherein the second thermosensitive coloring layer is not laminated.

28. A method of manufacturing a multicolor thermosensitive recording medium, comprising the steps of:
forming a first thermosensitive coloring layer on one surface of a substrate;
forming a desensitized region which desensitizes or dulls the coloring function in part of the first thermosensitive coloring layer; and
forming a second thermosensitive coloring layer so as to cover the desensitized region on the first thermosensitive coloring layer over a wider region than the desensitized region, using a coloring material which develops a different color from the first thermosensitive coloring layer.

29. A method of manufacturing a multicolor thermosensitive recording medium, comprising the steps of:
forming a desensitized region which desensitizes or dulls the coloring function in part of a first thermosensitive coloring layer formed on a substrate; and
forming a second thermosensitive coloring layer so as to cover the desensitized region on the first thermosensitive coloring layer over a wider region than the desensitized region, using a coloring material which develops a different color from the first thermosensitive coloring layer.

30. A method of manufacturing a multicolor thermosensitive recording medium, comprising the steps of:
forming a first thermosensitive coloring layer on one surface of a substrate;
forming a desensitized region which desensitizes or dulls the coloring function in part of the first thermosensitive coloring layer; and
forming a second thermosensitive coloring layer on the desensitized region of the first thermosensitive coloring layer, using a coloring material which develops a different color from the first thermosensitive coloring layer.

31. A method of manufacturing a multicolor thermosensitive recording medium, comprising the steps of:
forming a desensitized region which desensitizes or dulls the coloring function in part of a first thermosensitive coloring layer formed on a substrate; and
forming a second thermosensitive coloring layer on the desensitized region of the first thermosensitive coloring layer, using a coloring material which develops a different color from the first thermosensitive coloring layer.

32. A method of forming a multicolor thermosensitive recording medium, comprising the steps of:
forming a first thermosensitive coloring layer on one surface of a substrate;
forming a second thermosensitive coloring layer on this first thermosensitive coloring layer; and
forming a desensitized region which desensitizes or dulls the coloring function in part of the second thermosensitive coloring layer.

33. A method of forming a multicolor thermosensitive recording medium, comprising the steps of:
forming a second thermosensitive coloring layer on a first thermosensitive coloring layer formed on a substrate; and
forming a desensitized region which desensitizes or dulls the coloring function in part of the second thermosensitive coloring layer.

34. A printing method using a multicolor thermosensitive recording medium as defined in claim 21, 22, 23 or 25, comprising the steps of:
printing in mixed colors by heating with heating means in a part wherein the first thermosensitive coloring layer and the second thermosensitive coloring layer are laminated; and
printing in a monochrome color of the second thermosensitive coloring layer by heating with heating means in a part of the second thermosensitive coloring layer over the desensitized region.

35. A printing method using a multicolor thermosensitive recording medium as defined in claim 26, comprising the steps of:
printing in mixed colors by heating with heating means in a part wherein the first thermosensitive coloring layer and the second thermosensitive coloring layer are laminated;
printing in a monochrome color of the second thermosensitive coloring layer by heating with heating means in a part of the second thermosensitive coloring layer over the desensitized region; and
printing in a monochrome color of the first thermosensitive coloring layer by heating with heating means in a region of the first thermosensitive coloring layer wherein the second thermosensitive coloring layer is not laminated.

36. A printing method using a multicolor thermosensitive recording medium as defined in claim 24 or 25, comprising the steps of:
printing in mixed colors by heating with heating means in a part wherein the first thermosensitive coloring layer and the second thermosensitive coloring layer are laminated; and
printing in a monochrome color of the first thermosensitive coloring layer by heating with heating means in the desensitized region of the second thermosensitive coloring layer.
